(19) United States
(12) Patent Application Publication
(10) Pub. No.: US 2008/0184272 A1
(43) Pub. Date: Jul. 31, 2008

(54) DOCUMENTATION SYSTEM FOR LOSS CONTROL

(76) Inventor: Michael L. Brownewell, Lyons, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 12/023,751

(22) Filed: Jan. 31, 2008

Related U.S. Application Data
(63) Continuation-in-part of application No. 11/154,173, filed on Jun. 16, 2005.
(60) Provisional application No. 60/580,211, filed on Jun. 16, 2004.

(51) Int. Cl. G06F 3/00

(52) U.S. Cl. 719/318

(57) ABSTRACT

Systems and methods of documenting an event are disclosed. Events may include, but are not limited to, an accident, a crime, transportation of cargo, a medical procedure, a legal proceeding, an economic transaction, and/or a construction project. An event may be documented by data including, but not limited to, optical and/or audio records of the event. The records of the event may be watermarked and/or encrypted. The event documentary may be accessible only via a database storage service bureau that has been certified to maintain accurate and authentic data by a party acceptable to a judicial system. The documentary may be admissible in a court of law. The documentary may be useful for determining the cause of an event and/or preventing a future event.

### RELATED APPLICATIONS

This patent application is a continuation-in-part of pending U.S. patent application Ser. No. 11/154,173, filed Jun. 16, 2005, entitled “Video Documentation for Loss Control,” which is incorporated by reference in its entirety herein and claims priority to U.S. Provisional Patent Application Ser. No. 60/580,211, filed Jun. 16, 2004, which is also incorporated by reference in its entirety herein.

### BACKGROUND

The examples of the related art presented herein and limitations related therewith are intended to be illustrative and not exclusive. Other limitations of the related art will become apparent to those of skill in the art upon a reading of the specification and a study of the drawings.

Loss control has historically consisted of a series of checks and balances to guarantee the transfer and/or delivery of cargo. This was achieved by having both the delivering party and the receiving party sign paper documents, each confirming the amounts and specific locations of the delivered cargo. Electronic signatures have since replaced paper documents in some circumstances. On Jun. 30, 2000, the Electronic Signatures in Global and National Commerce Act (E-SIGN Act) was signed to establish the validity of electronic signatures for interstate as well as international commerce.

The ability to prove actual occurrences while cargo is in the care, custody, or control of those with legal responsibility for delivering cargo often relies on witness or third-party testimony. An example is the transportation industry in the United States. In the transportation industry in the United States, typically only the operator of a vehicle provides a point-of-view statement. Following an accident, all witnesses are questioned in an attempt to determine where fault lies. Such statements are often all a court has with which to validate a participant's claim of fault or negligence of a second party.

### SUMMARY

In view of the foregoing, one objective of embodiments of the present invention is to provide methods and apparatuses operable to record information and/or events in a manner that may be verified at a later point in time.

Another objective is to provide a cost-effective method of documenting events. In this regard, a relatively large number of events may be recorded, and only recordings of specific events may go through a verification process.

Another objective is to provide methods of operation of a documentation services provider providing documentation authenticity verification services. The documentation services provider may provide equipment and/or software operable to encode recordings of events such that the any subsequent modification or tampering with the recordings may be detectable by the documentation services provider.

Another objective is to provide a method of documenting events by a user where the user-created documentation may later be admitted into a legal proceeding. A related objective is to provide apparatuses to enable user-created documentation to be later be admitted into a legal proceeding.

One or more of the above objectives may be realized in embodiments of the present invention.

One or more of the above objectives may be realized in provided methods and apparatuses operable to record information and/or events in a manner that may be verified at a later point in time. Such verification may take the form of reviewing the recording device and/or recorded information and determining whether or not the recording device and/or recorded information has been altered or tampered with. The verification may be used to aid in submission of the recordings into a legal proceeding such as a court case and/or arbitration. The verification may allow entry of the recordings into legal proceedings without a customary chain of custody showing by a governmental entity. In such a process, intermediate handling and possession of the recorded data may be irrelevant, allowing an interested party to capture and store the recording prior to verification.

The verification may be performed by an independent third party. Verification may include verifying that the recorded data is currently in the same form and/or condition as it had been at the time of its original recording. The verification may also confirm the time the recording was made and/or the location where the recording was made.

The independent third party may supply a user the equipment and/or software to record data and/or events. The recording may be of anything that can be digitized: for example video, audio, still images, documents, and computer files. The recording may be watermarked. The recording may be encrypted. The recording may be watermarked and encrypted. The independent third party services provider may provide watermarking and/or encryption technologies to the user. The watermarking may be implemented such that only the independent third party (and its designates) may have the ability to review the recording and determine whether or not the watermarking is unaltered (and therefore whether or not the recording is unaltered). The encryption may be implemented such that only the independent third party (and its designates) may have the ability to decrypt the file and determine its authenticity.

The equipment supplied by the third party may be tamper-resistant and may be configured such that a user may record events and/or data but may not edit such recordings. In this regard, if the recording unit is returned to the third party, the third party may examine the unit, determine that it has not been tampered with, and therefore be able to certify that the data recorded on the unit has not been altered after its initial recording.

After verifying that a particular recording made has not been altered or tampered with, a representative of the third party may testify as to the third party's processes and methods and as to the authenticity of the recording in a legal proceeding.

A user may create hundreds, thousands, or more recordings a year to document items such as, for example, property transfers, accidents (e.g., industrial and vehicular), property condition, documents, and statements (such as assent to an agreement, depositions, descriptions). However, only a very small percentage of the recordings may be required to be later verified as unaltered for use, for example, in settling a dispute. The user may document all of the items and store them under the user's control (e.g., in a centralized computer storage location). In those few cases where a dispute arises, the user may forward the item to the third party and the third party may verify the authenticity of the item and distribute the item as requested by the user (e.g., to an opposing party, an arbitrator or a court). In this regard, the added expense of verification by the third party may only be incurred where a dispute arises. In another method of documenting the items, all of the recordings may be forwarded to the third party for archival by the third party.

In one aspect, a method of documenting the transfer of property from a first party to a second party is provided. The method may include displaying to a representative of the second party information related to the property while recording a signature of the representative. The signature of the representative may acknowledge the accuracy of the displayed information. The signature may be recorded with an electronic signature-recording device. The method may further include associating the recorded signature with the information and encoding the recorded signature and the information such that alteration of the encoded recorded signature and/or the encoded information is detectable.

In an embodiment, the first and/or second parties may be common carriers. The property may be cargo. The property may include hazardous materials. In an embodiment, the information related to the property may include a written description of the property and/or a written description of terms of the transfer of property agreed to by the first and/or second party. The information may be in the form of audio information such as, but not limited to, a verbal description of the property and/or a verbal assent to the conditions of the transfer of the property. The information may be in the form of visual information, such as at least one digital still image and/or video.

In an arrangement, the recording and displaying may be performed with a data input device. After the transfer of property, the data input device may be transferred to the second party. The data input device may remain with the property after the property is transferred to the second party. In an arrangement a portion of the data input device, such as a removable memory device, may be transferred from the first party to the second party.

In an embodiment, the method may further include digitally recording audio and/or visual information related to the property contemporaneously with the transfer of the property. In this regard, the associating step may further include associating the audio and/or visual information to the recorded signature. The encoding step may further comprise encoding the audio and/or visual information such that alteration of the encoded audio and/or visual information is detectable. The visual information may include at least one digital still image and/or video.

In an approach, the encoding may encrypt the recorded signature and the information. The encryption may occur simultaneously with the recording. In an embodiment, the method may further include digitally storing, in at least one data file, the encoded recorded signature and the encoded information.

In an arrangement, the method may include transmitting the information to a remote location. The transmission may be to a third party. The third party may be a documentation services provider. The third party may verify that the information has not been altered.

In another aspect, a method of documenting an event is provided that may include obtaining a recording device from a documentation verification services provider, recording digital information related to the event with the recording device, and encoding the digital information. In an implementation, the recording device may be tamper-resistant.

In an embodiment, the event may be agreement by a party to at least one condition. Data related to the at least one condition may be displayed to the party. The agreement by the party may acknowledge the validity of the at least one condition. The agreement may be by a signature of the party and the digital information may include the signature and the at least one condition. The agreement may be verbal and the digital information may include a recording of the verbal agreement and the at least one condition. The recording of the verbal agreement may be an audio recording and/or a video recording.

In an embodiment, the event may result in a loss. For example, the event may be an accident (e.g., industrial, vehicular), a crime, or a hazardous material spill. In an embodiment, the event may be a proceeding (e.g., medical, legal). In an embodiment, the event may be an investigation, such as an investigation of an accident, a hazardous material spill and/or a crime. The recording of digital information may include at least one of audio, still images and video of the event.

In an arrangement, the encoded digital information may be watermarked and/or encrypted. The method may further include transmitting the watermarked and/or encrypted information to the documentation verification services provider. The transmitting may include transmitting over at least one of a satellite network, a telephone network, a wireless network, a computer network and the Internet. The documentation verification services provider may verify the authenticity of the watermarked and/or encrypted information.

In another aspect, a method of verifying an event is provided that may include providing a recording device to a client and receiving the recording device back from the client after the providing step, wherein while the recording device was in control of the client, the recording device was used to make a recording of the event. The method may further include verifying after the receiving step that the recording device has not been tampered with. This method may, for example, be practiced by a documentation service provider. In an embodiment, the method may further include certifying that the recording has not been altered. The certifying may be accomplished by, inter alia, examining the recording device for evidence of tampering and/or examining the recording of the event for evidence of alteration. The examining of the recording of the event may include examining the watermarking and/or encryption of the recording. In an arrangement, the method may further comprise decrypting the recording. In an embodiment, the certified recording may be operable to be admitted as evidence in legal proceeding.

In still another aspect, a method of verifying an event is provided that may include providing a recording device to a client and receiving a digital file from the client, wherein the digital file contains a recording of the event made by the client with the recording device. The method may further include verifying after the receiving step that the digital file has not been tampered with. This method may, for example, be practiced by a documentation service provider. In an embodiment, the method may further include certifying that the recording has not been altered. The certifying may be accomplished by, inter alia, examining the recording of the event for evidence of alteration. The examining of the recording of the event may include examining the watermarking and/or encryption of the recording. In an arrangement, the method may further comprise decrypting the recording. In an embodiment, the certified recording may be operable to be admitted as evidence in legal proceeding.

In yet another embodiment, an information-recording unit is provided that may include a housing, a user interface, a sensor, a time determination subsystem, a processor, and a memory. The user interface may be operable to receive instructions from a user. The sensor may be operable to encode received information to produce encoded information. The sensor may comprise a microphone, a still camera, and/or a video camera. The time determination subsystem may be operable to determine a time when the encoded information is produced. The processor may be operable to combine the encoded information with the time determined by the time determination subsystem into at least one digital file such that any alteration of the at least one digital file may be detectable. The memory may be operable to store the at least one digital file.

In an approach, the information-recording unit may comprise a cellular phone, a walkie-talkie, and/or a personal data assistant (PDA). In an embodiment, the housing may be tamper resistant. In an embodiment, the sensor may include two video cameras directed toward unique fields of view. The two video cameras may be disposed to capture video of a subject and of a user of the information-recording unit simultaneously.

In an arrangement, the information-recording unit may include a data input terminal. The information-recording unit may be operable to receive data through the data input terminal. The information-recording unit may be operable to watermark and/or encrypt data received through the data input terminal. The data received through the data terminal may be any appropriate data file including, but not limited to, a word processing file, a portable document file (pdf), a database file, an email, an image file, and/or a video file.

In an embodiment, the time determination subsystem may comprise a GPS receiver. The GPS receiver may be operable to acquire the current time and/or the location of the information-recording unit. The processor may be further operable to combine the encoded information with location information derived from the GPS receiver into the at least one digital file. In an embodiment, the time determination subsystem may be a module operable to obtain the current time from a cellular phone network, an internal clock, and/or a radio broadcast that includes the current time. The time determination subsystem may be unalterable by the user. In this regard, the user may not be able to enter a time into the information-recording unit.

In an approach, the information-recording unit may further include a signal generator operable to generate a signal. In this regard, the at least one digital file may be at least partially produced from the signal. In an arrangement, the signal generator may be an audio speaker and the signal may be an acoustic signal. In such an arrangement, the combining of the signal with the received information may occur at a microphone of the sensor. In an arrangement, the signal may include a signal type selected from a group of signal types consisting of: a numerical repeating sequence; an alphabetical repeating sequence; an alphanumeric repeating sequence; a timed on/off sequence where the on/off intervals are uniform; a timed on/off sequence where the on/off intervals are non-uniform; a data stream; and a data pulse.

In an embodiment, the information-recording unit may be remotely activatable. In an embodiment, the information-recording unit may further include an encryption module operable to encrypt the at least one digital file. In an embodiment, the information-recording unit may further include a magnetic strip reader and/or an electronic signature capture device.

In an approach, the information-recording unit may further comprise an identification subsystem. The identification subsystem may be operable to identify a person by analyzing the encoded information using, for example, facial, fingerprint, retina, and/or voice recognition. To enable fingerprint scanning, the information-recording unit may include a fingerprint scanner. The identification subsystem may also identify a person by reading an identification card, confirming a password and/or any other appropriate method.

In another aspect, a method of documenting an event is provided that may include obtaining a signal generator from a documentation verification services provider, activating the signal generator such that the signal generator generates a signal, and recording the event with a recording device to produce a recording of the event. The method may further include combining the recording of the event with the signal to produce combined data, and storing the combined data in a memory. The combining of data may include watermarking and/or encrypting the data. Accordingly, the data being stored may be watermarked and/or encrypted.

The signal generator may be a stand-alone device operable to be plugged into a recording device. For example, the signal generator may be operable to be plugged into a cellular phone, PDA or other device with recording capabilities. As used herein “plugged in” may also include wirelessly connecting, such as wireless connecting the signal generator to the recording device using Bluetooth™ technology. In this regard, in an embodiment, the method may further include plugging the signal generator into the recording device.

In an embodiment, the recording may include audio recordings, still images and/or video of the event. In an arrangement, the recording step may include recording the event with two video cameras, where one video camera captures video of the operator of the recording device as the operator captures video of the event with the other video camera.

In an embodiment, the method of documenting an event may include transmitting the stored information to the documentation verification services provider. The stored information transmitted to the documentation services provider may be watermarked and/or encrypted.

In yet another aspect, a method of verifying an event is provided that may include providing a signal generating device to a client and receiving a data file from the client after the providing step, wherein the data file was created by combining at least one of audio data, image data and video data with a signal generated by the signal generator. The method may further include verifying, after the receiving step, that the data file has not been altered since the combining.

In an embodiment, the method may include certifying that the recording has not been altered. The certifying may be performed after the data file has been verified as unaltered. The verifying may be accomplished by, for example, examining a watermark disposed within the data file. In an arrangement, the signal-generating device may be tamper resistant. In an arrangement, the signal-generating device may include a time determination module operable to determine a current time independent of user input.

Numerous additional aspects, features and advantages of the present invention will become apparent to those skilled in the art upon consideration of the further description that follows. Any of the embodiments, arrangements, approaches or features discussed above with respect to a particular aspect may be incorporated in other aspects of the present invention.

### GLOSSARY

The following terms are defined herein and will be used consistently throughout this document to mean:

1) “point A”: the location and/or time that any cargo becomes a user's responsibility through written contract, by implication through customary business practice, and/or by the designation of any court of law in the territory wherein an occurrence damages the cargo.

2) “point B”: the location and/or time that the user relinquishes the cargo and/or the responsibilities assumed at Point A.

3) “cargo”: any tangible or intangible property or data, that is in user care, custody and/or control, or any tangible or intangible property or data, including money in electronic transit, that is under user direction by written contract, by implication through customary business practice, or by the designation of any court of law recognized by the government in the territory wherein an occurrence takes place. For example, cargo includes but is not limited to, funds being transferred by bank wire, credit card, or check, as well as real property, product serial numbers, batch numbers, and percentage of completion of a project.

4) “occurrence”: an event that results in bodily injury, property damage, property loss, loss of income (e.g., due to delay in transit), damage to cargo, or any activity interpreted as a user's responsibility by a court of law recognized by the government in the territory wherein the activity takes place, or any event that a party may wish to document for possible introduction into a legal proceeding.

5) “event trigger”: any action that precipitates and/or causes an occurrence.

6) “field of view”: the area encompassing the image recorded by a camera.

7) “cause of loss”: the description of an event that results in an occurrence.

8) “loss control”: any action that would reduce the risk and/or frequency of a loss or any action that would identify a cause of a loss.

9) “third party compliant”: state where a disinterested, independent party (such as a third party database storage service bureau) has certified the accuracy and/or authenticity of a process, method, good, tangible or intangible property, and/or data.

10) “impact sensor”: mechanism for activation of “loop start” recording, including but not limited to, an accelerometer (or alternate method of determining acceleration, deceleration or directional change outside a vehicle's normal operating characteristics).

11) “angle sensor”: a device that determines the angle an item (e.g., cargo) is positioned at.

12) “temperature sensor”: a device that determines the temperature of an area of interest.

13) “pressure sensor”: a device that detects pressure and/or a change of pressure in an area of interest.

14) “contamination sensor”: a device that detects a change in the composition of cargo and/or an area of interest.

15) “panic switch”: a manual emergency switch that may be activated by a driver, machine operator, a remote party, a satellite communication protocol, etc.

16) “any unit”: any device that detects a change in conditions that have one or more effects on cargo and/or an area of interest, and is integrated into a monitoring system.

17) “construction related sensor”: any device that monitors and/or records changes in one or more of the following characteristics as they relate to building or construction site: temperature, pressure, moisture, noise, atmospheric contamination, motion, vibration, soil conditions, or other characteristics.

18) “flow sensor”: a device that determines a quantity of cargo loaded to a transport apparatus or unloaded from a transport apparatus.

19) “disabling substance”: any form of substance released into a contained or designated area intended to make the area hazardous, uninhabitable, and/or intended to disable any human in the area.

20) “fire extinguisher”: any device designed to contain, eradicate, or extinguish a fire.

21) “audio signal device”: a device that makes noise (e.g., a horn) or that can be used to transmit a voice and/or an audio signal.

22) “any device”: any item that is connected to a system, any item that is activated or turned on either directly or indirectly by the system, any item that adds a data field to the system, and/or any item that produces an output. Examples include, but are not limited to, an audio recording device and an offsite audio reproduction device.

23) “interface switch”: any device that completes a circuit from an information processor to any device that it is connected to.

24) “GPS”: global positioning system, which is a device designed to recognize the global position of a person or property via a system of satellites. A GPS device is also capable of supplying a timestamp referenced to the GPS timeframe.

25) “transceiver”: device that communicates with an external device; the transceiver may, inter alia, relay instructions for the protection of a person and/or property.

26) “encoder”: subsystem that encodes data and/or allows access to stored data by a disinterested, independent third party in the event of an incident. An encoder may also encrypt data.

27) “decoder”: device that processes signals received from an outside source. A decoder may also initiate a go sequence from the instructions.

28) “authenticate”: to verify the identity of and/or the condition of a person, an association, an entity, an apparatus, a transaction, data, tangible property, intangible property, and/or a process.

### BRIEF DESCRIPTION OF THE DRAWINGS

Exemplifying embodiments are illustrated in referenced figures of the drawings. It is intended that the embodiments and figures disclosed herein are to be considered illustrative rather than limiting. Also, the terminology used herein is for the purpose of description and not of limitation.

FIG. 1 is a block diagram of an event documentation system.

FIG. 2a is a flow chart showing interactions between various parties using an event documentation system.

FIG. 2b is a block diagram of a data input device.

FIG. 3a is a top view of a trucking application embodiment.

FIG. 3b is a side view of a crane and rigging application embodiment.

FIG. 3c is a side view of an intermodal/ocean cargo application embodiment.

FIGS. 4a and 4b are exterior and interior perspectives respectively of a commercial/industrial/residential real estate application embodiment.

FIG. 5a is a system representation of embodiments of cargo protection and controls (CPC), third party verification, and data information flow.

FIG. 5b is an illustration of an embodiment of a system used to document the transfer of property.

FIG. 5c is a flow chart of a process using the system of FIG. 5b.

FIG. 6 is a system representation of sensor data and other device input as well as other device input to a CPU.

FIG. 7 is a system representation of data flow with third party verification.

FIG. 8 is schematic representation of potential actions that may be taken as the result of an occurrence.

FIG. 9 is a schematic description of a DCA.

FIG. 10 is a flow chart of the CPC systems checks.

FIG. 11 is a flow diagram of an embodiment showing loss control procedures.

FIG. 12 is an example of an embodiment applying third party compliant data and storage to a medical application.

FIG. 13 is an example of an embodiment applying third party compliant data and storage to a legal application.

FIG. 14 is an example of an embodiment applying third party compliant data and storage to document a construction project.

FIG. 15a is an example of an embodiment of third party compliant data system integrated into a trucking industry application.

FIG. 15b illustrates the data flow of the system of FIG. 15a.

Before explaining disclosed embodiments of the present invention in detail, it is to be understood that the invention is not limited in its application to the details of the particular arrangements shown, since the invention is capable of other embodiments. Also, the terminology used herein is for the purpose of description and not of limitation.

### INTRODUCTION TO THE DETAILED DESCRIPTION

In light of the foregoing, actual event recording based on a third party recording and storage of the event would greatly enhance the validity of legal claims related to the event. What is needed is a third party, unbiased visual documentation of an event. Such visual documentation may present an unquestionable recount of events during court proceedings and may accurately challenge witness testimony related to the cause of events. What is also needed is the ability to verify pickup and delivery of any product to the intended party.

The following embodiments and aspects thereof are described and illustrated in conjunction with systems, tools, and methods which are meant to exemplify and illustrate, and not be limiting in scope. In various embodiments, one or more of the above-described problems have been reduced or eliminated, while other embodiments are directed to other improvements.

Systems and methods of documenting an event or occurrence are disclosed. The documentary of the occurrence may be developed such that it is accessible only by a third party database storage service bureau which has been certified to maintain accurate and authentic data. Thus, the documentary may be admissible in a court of law. The documentary may be useful for determining the cause of an occurrence and/or preventing future occurrences.

An event trigger subsystem may be used to activate a system documenting an occurrence. The event trigger subsystem may comprise devices, which automatically detect an occurrence. An example is an accelerometer, which may detect a vehicular accident due to a sudden change in speed. Additionally, an event trigger subsystem may comprise manually or remotely activated devices.

In the event of an occurrence, encrypted data comprising the documentary of the occurrence may be saved on a local data storage subsystem. Additionally, such encrypted data may be transferred to a remote location. Other actions, such as securing cargo, may be taken in the event of an occurrence.

A smart-card system may be used to control and track cargo. By way of example and not of limitation, the smart-card system may track cargo consisting of fuel to insure it was shipped along a specific route, unloaded successfully at one or more locations, and accepted by each customer along a route.

Other features and embodiments will appear from the following description and appended claims and by referring to the accompanying drawings, which form a part of this specification, wherein like reference characters designate corresponding parts in the several views.

### DETAILED DESCRIPTION

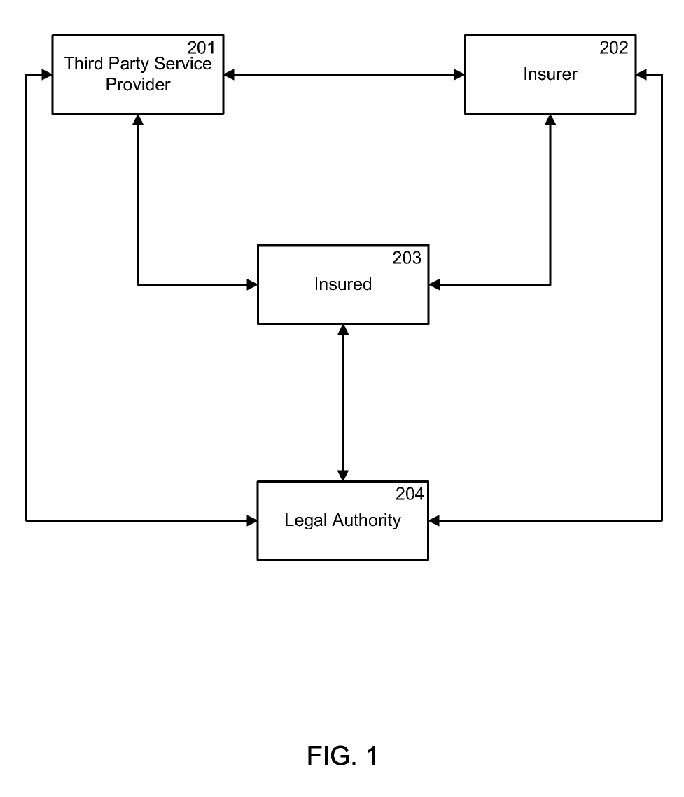

FIG. 1 is a block diagram of an event documentation system. In the system, a Third Party Documentation Verification Services Provider 201 (hereinafter referred to as a third party services provider 201) may provide event documentation and verification services and/or hardware. The hardware may include a device or devices able to record events. The recording of the event may, for example, include an audio recording, a visual recording (still images or video), and/or a recording of a party agreeing to terms or conditions. The agreement of the party may be in the form of a recording of signature(s), mark(s), fingerprint(s), or any other means a party may use to signify agreement.

The hardware provided by the third party services provider 201 may be tamper-resistant. For example, the hardware may be sealed in such a manner that any opening of the device may be detectable. In this regard, any appropriate tamper detection method may be utilized. The hardware may record the recorded data in such a manner that post-recording tampering of the data may be detected. In this regard, once the data is recorded and/or the hardware is inspected, the authenticity of the recorded data may be verifiable by the third party services provider 201.

An Insurer 202 may integrate the use of the event documentation and verification hardware into its operations. For example, the Insurer 202 may, in certain circumstances, require the use of the event documentation and verification hardware by an Insured 203 party to document certain events as a precondition for offering insurance. For example, the Insurer 202 may, in certain circumstances, offer discounted rates if the Insured 203 agrees to use the event documentation and verification hardware to document certain events (e.g., events and/or perils covered under an insurance policy, often referred to as “covered perils”). The Insurer 202 may obtain the event documentation and verification hardware directly from the third party services provider 201 and then distribute the hardware to the Insured 203. Alternatively, the Insurer 202 may require that the hardware be obtained by the Insured 203 directly from the third party services provider 201. The Insured 203 may be self-insured, in which case the functions performed by the Insurer 202 described herein may be performed by the Insured 203.

Under certain circumstances, the Insurer 202 and/or the Insured 203 may wish to obtain verified copies of the data recorded by the event documentation and verification hardware and enabling software. This may be accomplished by uploading the data from the event documentation and verification hardware to the third party services provider 201 and/or delivering the event documentation and verification hardware or a portion thereof (e.g., a memory storage device) to the third party services provider 201. The third party services provider 201 may then verify that the data recorded by the event documentation and verification hardware has not been tampered with. The third party services provider 201 may then certify a copy of the data as unaltered and forward it to the Insurer 202 and/or Insured 203 and/or any other appropriate party.

Under certain circumstances, the Insurer 202 and/or the Insured 203 may be involved in legal proceedings where it may be desired to introduce the data recorded by the event documentation and verification hardware into evidence with a Legal Authority 204. The Legal Authority 204 may, for example, be part of an administrative hearing, a local, state or federal court, a governmental proceeding, or an arbitration proceeding. As part of the submission of the recording to the Legal Authority 204, the third party services provider 201 may provide a witness to testify as to the authenticity of the recorded data. This testimony may include information related to the third party services provider's 201 practices and the chain of custody for the recorded information. Where the third party services provider's 201 practices are known by the Legal Authority 204, it may be possible for the Insurer 202 and/or the Insured 203 to introduce a certified copy of the recording into the legal proceeding.

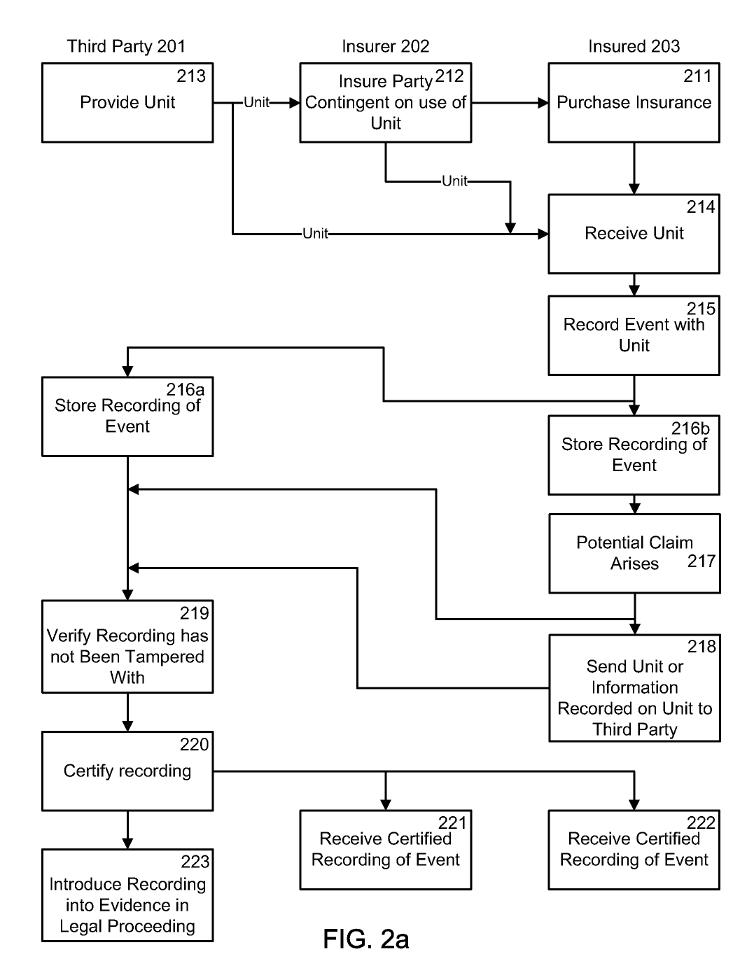

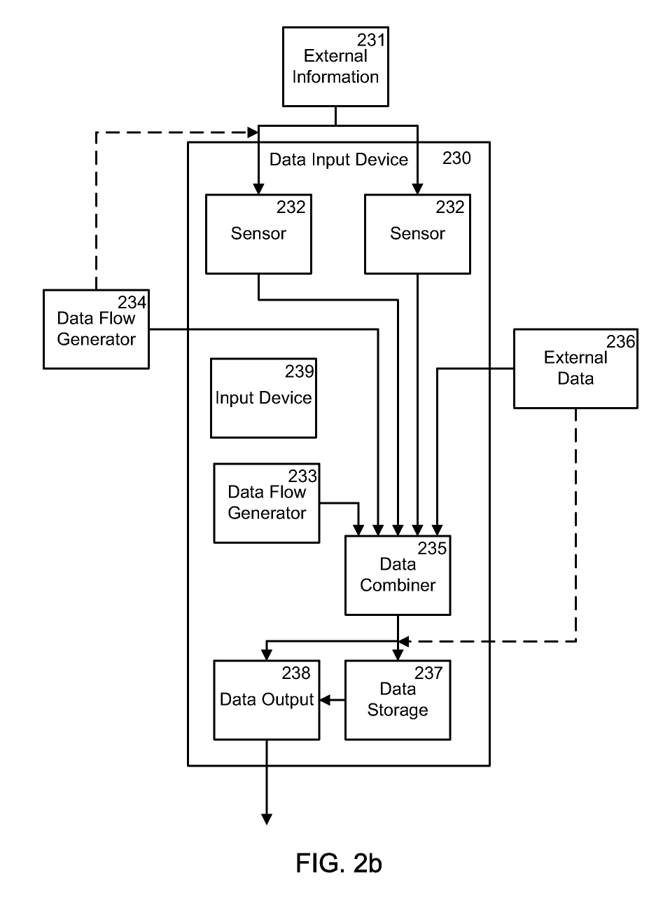

FIG. 2a is a flow chart showing interactions between the various parties using an event documentation system. The first column represents actions that may be taken by the third party services provider 201, the second column represents actions that may be taken by the Insurer 202, and the third column represents actions that may be taken by the Insured 203.

The first step 211 may be for the Insured 203 to purchase insurance from the Insurer 202. The Insurer 202 may offer the insurance policy contingent 212 on the use of event documentation and verification hardware, which may be in the form of an event documentation and verification unit (“unit”) provided 213 by the third party services provider 201. The use of the unit to record an event may be a precondition for obtaining insurance and/or a precondition for insuring a covered peril. In the next step 214, the Insured 203 may receive the unit either from the Insurer 202 or directly from the third party services provider 201.

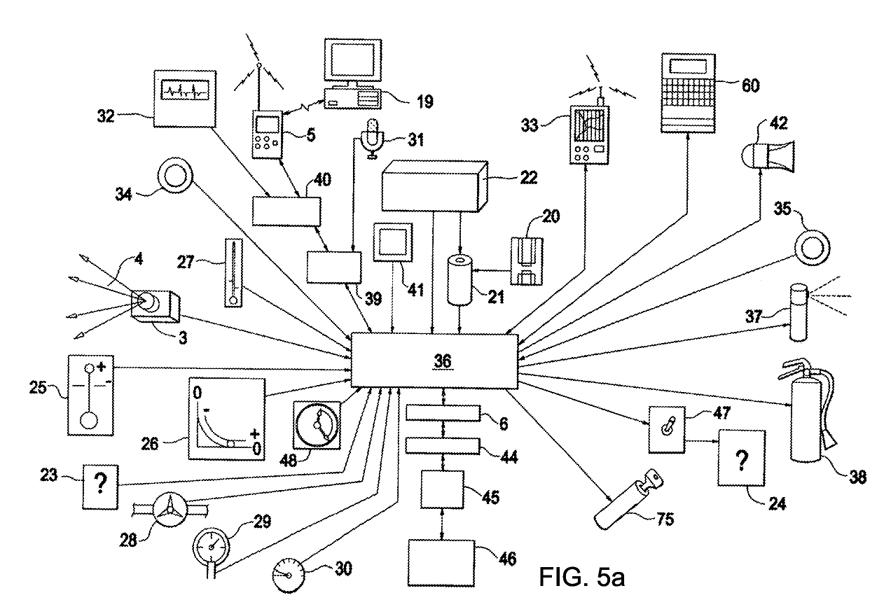

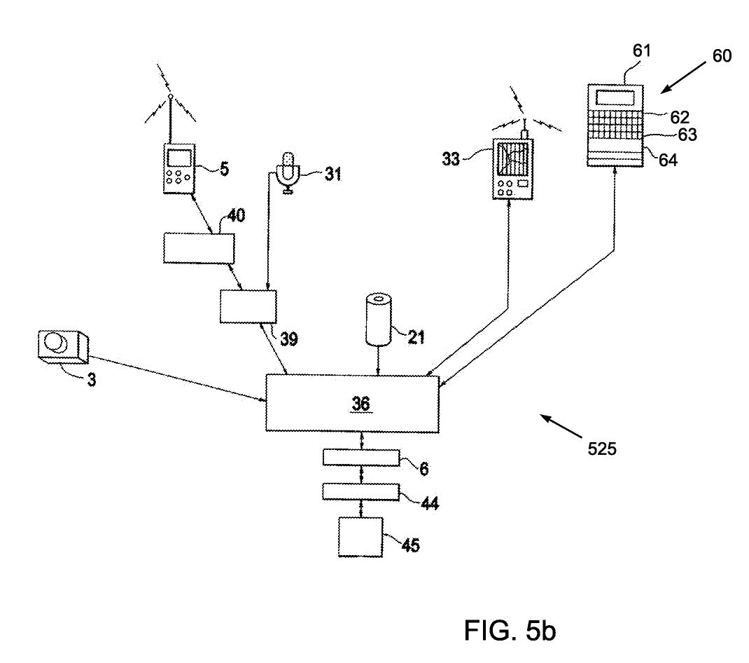

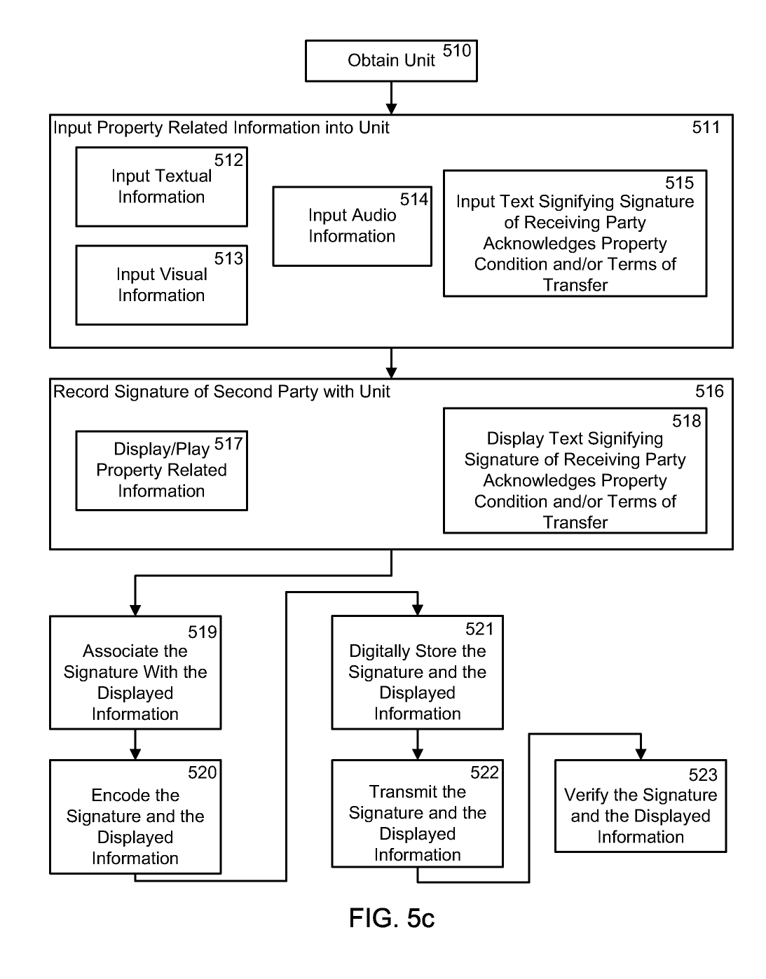

In step 215, the Insured 203 may record an event (e.g., a covered peril) with the unit. The event may be any recordable event that the Insured 203 and/or Insurer 202 may later wish to introduce into a legal proceeding. For example, the unit, in hand held form, may be used to record the signature on a manifest of a party taking possession of insured items, such as cargo. This scenario is discussed below with reference to FIGS. 5b and 5c. In another scenario, the event may be the condition and/or configuration of an item or items at a particular point in time. For example, the Insured 203 may record video footage of the condition of cargo at the time of transfer to another party. The video footage may show the condition (e.g., undamaged) and/or the configuration (e.g., number of items) as well as showing how the cargo was positioned and/or secured for transport.

In another embodiment, the event may be an accident (as discussed below) and/or the aftermath of an incident. For example, if a container carrying insured cargo were to be involved in a traffic accident, the insured 203 may use the unit (e.g., in hand held form) to record 215 video footage of the damage to the cargo while it is still in the post-traffic-accident position. This may, for example, later be used to support claims that the damage to the cargo was a result of the traffic accident.

In yet another embodiment, the event may be the aftermath of a spill of hazardous materials. The insured 203 may use the unit, in hand held form, to record 215 video footage of the extent and volume of the spill. This may later be used, for example, to support claims as to the extent of the spill. The insurer 202 may issue an insurance policy to the owner of the hazardous material contingent on the use of a unit by parties handling and/or transporting the hazardous material to document the handling and transportation of the hazardous material. The insurer 202 may also require any party handling or transporting the hazardous material to document any spills with the unit. The unit may follow the hazardous material and as such be transferred from entity to entity as the hazardous material is transferred from entity to entity. In this regard, the insurance may be issued to the owner of the hazardous material and/or a party responsible for the hazardous material and may follow the hazardous material as it is transferred, handled, and/or transported.

Any video recording may be accompanied by audio recording. For example, the party recording the video may also provide a narrative of the scene or a brief description of relevant events prior to the recording.

The event may be recorded with a system that includes portions that are not hand held. Described herein are systems and methods that are attached to items such as trucks, cargo containers, cranes, buildings and rooms. These may be used to record events such as traffic accidents, industrial accidents, cargo handling (e.g., crane) related incidents, medical proceedings, legal proceedings, crimes, and other events. Furthermore, hand held units may also be used to document these same events, for example, by placing the hand held units in cradles or other mounts. Such hand held units may be totally self-contained or may interface with portions of the aforementioned systems.

Contemporaneously with the recording 215 of the event, the recording of the event may be encoded and stored 216a, 216b. From the perspective of the insured 203, a method of documenting an event may include the steps of obtaining the unit from the third party (receive unit 214), recording information (e.g., digitally recording) related to the event with the unit 215, and encoding the information. From the perspective of the third party services provider 201 and as discussed further below, the process may include providing 213 the unit to the insured and receiving a recording of the event made with the unit by the insured. The recording may be received by transferring a digital file of the recording of the event from the insured and/or insurer to the third party services provider 201 in any appropriate manner, including transferring the unit containing the recording to the third party services provider 201. The process may further include verifying by the third party services provider 201 that the digital file has not been tampered with.

The encoding of the recorded event may be performed in a manner such that subsequent tampering of the recorded data may be detectable by the third party services provider 201. The encoding may include encryption. The encryption may be such that only the third party services provider 201 or parties authorized and enabled by the third party services provider 201 may view the contents of an encrypted file. The recording 215 of the event may occur simultaneously with the encoding. The recording of the event may occur simultaneously with the encoding of the event and the encryption. Encryption systems and methods are further discussed below with reference to FIG. 2b.

The storage of the recording of the event may be local. For example, the recorded event may be stored 216b onto a hard drive or other memory system that is a part of the event documentation and verification hardware unit. The Insured 203 may retain the stored files in the unit and/or may download the files onto another storage device controlled by the Insured 203.

In place of or in addition to the locally stored event, the recording of the event may be transferred to the third party services provider 201. For example, the unit may record the event and then transmit the recording of the event to the third party services provider 201 for storage 216a by the third party services provider 201. The transmission of the recording of the event to the third party services provider 201 may occur via any appropriate means. For example, the unit may be operable to transmit the recording via a cellular communications network, a satellite network, a wireless computer network, an Internet connection and/or the public switched telephone network. The recording of the event may also be transferred to the third party services provider 201 by sending the unit, or a portion thereof (e.g., a memory card or portable hard drive), to the third party services provider 201. The third party services provider 201 may then store the recording in any appropriate manner.

As illustrated in FIG. 2a, a potential claim may arise 217 after the recording of the event. For example, the recorded event may have been the transfer of cargo from a first party to a second party. Subsequently, the second party may make a claim as to the condition of the cargo at the time of transfer. The first party may then wish to use the recording of the transfer to help establish the condition of the cargo at the time of transfer.

The potential claim may also arise 217 before the recording of the event 215 or simultaneously with the recording of the event 215. In the former case, the potential claim may arise in the form of a traffic accident or hazardous waste spill as previously described and the unit may be used to document conditions shortly thereafter. In the latter case, the potential claim may arise at the same time as the recording is made, such as in the case described herein where the unit is operable to record a traffic accident as it occurs.

After a claim has arisen 217, and where the event recordings were stored 216b locally by the insured 203, the recording of the event may be transferred to the third party services provider 201. This transfer may occur in any of the manners described above.

After a potential claim has arisen 217 and the recording of the event is in the possession of the third party services provider 201, the third party services provider 201 may perform the step 219 of verifying that the recording has not been tampered with. The third party services provider 201 may verify that the recording has not been tampered with in any appropriate manner. For example, the third party services provider 201 may verify the recording has not been tampered with by examining the encoding, encryption, digital watermark, and/or any other appropriate characteristic of the recording. The third party services provider 201 may also examine the media on which the recording is stored and/or the unit. The process of verification may include decoding and/or decrypting the recording of the event.

If the third party services provider 201 determines that the recording has not been tampered with, the third party services provider 201 may perform the step 220 of certifying the recording as unaltered. The certification may include a statement as to facts related to the recording such as time of recording, location of recording (e.g., where the unit has GPS capabilities), or any other appropriate parameter. The third party services provider 201 may then forward a certified copy of the recording to the Insurer 202 and the Insured 203. The Insurer 202 may receive the certified recording of the event 221 and review it to help determine an appropriate course of action. Similarly, the Insured 203 may receive the certified recording of the event 222 and review it to help determine an appropriate course of action.

The Insurer 202 and/or Insured 203 may desire to have a certified recording of the event entered into evidence in a legal proceeding. The Insurer 202 and/or Insured 203 may be permitted to introduce a certified recording of the event into the legal proceedings. In another scenario, the third party services provider 201 may be required to introduce a certified recording of the event into evidence in the legal proceeding 223. The third party services provider 201 may testify as to the third party services provider's 201 practices such as methods used to determine that the recording was not tampered with. The third party services provider 201 may also testify as to the chain of custody of the certified recording introduced into evidence. The third party services provider 201 may also testify as to any other appropriate fact, procedure, method, and/or technical subject relevant to the introduction of the certified recording of the event into the legal proceeding. The legal proceeding may, for example, be in front of administrative court, a local, state or federal court, or an arbitrator.

FIG. 2b is a block diagram of a data input device 230. The data input device 230 may be operable to receive data in a wide variety of forms. For example, the data input device 230 may operable to record audio or video information, capture still images, receive digitized data, and/or sense local conditions. Where the data input device 230 is capable of recording information, it may be referred to as an information-recording unit. The data input device 230 may be capable of adding a watermark and/or encryption to the data that it receives/senses. Furthermore, the data input device 230 may be capable of outputting data in a wide variety of forms. For example, the data input device 230 may be operable to display recorded data, write recorded data to a portable memory device, and/or transmit data from the data input device 230 via a removable connector and/or wireless connection.

A watermark added to data by the data input device 230 may create watermarked data in such a manner that subsequent alteration of the data may be detectable. For example, alteration of watermarked data may result in a detectable gap or unexpected change in the watermark, which may indicate that the data has been tampered with or altered. The watermark may be produced by combining the inputted data with data from a data flow generator 233 discussed below. In images, such as digital still images or digital video footage, the watermark may be visible or invisible to a user. In audio data, such as digital audio, the watermark may be audible or inaudible to a user. The watermark may be produced using any appropriate technique. As previously noted, the encoding of the recorded event may be performed in a manner such that subsequent tampering of the recorded data may be detectable by the third party services provider 201.

Consequently, watermarked data may be operable to be used (e.g., viewed, listened to, read) by a party without regard to the watermark. For example, a digital image may be operable to be viewed, copied, and distributed in the same manner as non-watermarked digital images. In this regard, a user may distribute watermarked data and allow other parties to review the data, while the ability of a third party services provider 201 to examine the watermarked data file to verify that it has not been tampered with remains in tact.

The inputted data may be encrypted. The data that is encrypted may or may not be watermarked. The encrypted data may only be accessible by a limited number of parties. For example, the encrypted data may only be accessible (e.g., able to be decrypted) by the third party services provider 201. The encryption may take any appropriate form known to those skilled in the art of encryption. For example, the encryption may employ a cryptographic module following known standards such as specified in “Security Requirements For Cryptographic Modules,” Federal Information Processing Standards Publication 140-2 (FIPS PUB 140-2), including revisions. FIPS PUB 140-2 specifies the security requirements that may be satisfied by a cryptographic module utilized in a security system protecting sensitive information within computer and telecommunications systems.

In this regard, the cryptographic module may be a set of hardware, software, firmware, or some combination thereof that implements cryptographic functions or processes, including cryptographic algorithms and, optionally, key generation, and is contained within a defined cryptographic boundary. A cryptographic module may implement at least one approved security function used in and approved mode of operation. A cryptographic boundary may consist of an explicitly defined parameter that establishes the physical bounds of the cryptographic module. In the case where the cryptographic module consists of software or firmware components, the cryptographic boundary may contain the processor(s) and other hardware components that store and protect the software and firmware components. A cryptographic module may support authorized roles for operators and corresponding services within each role. Authentication mechanisms may be required within a cryptographic module to authenticate an operator accessing the module, and to verify that the operator is authorized to assume the requested role and perform the services within the role. A cryptographic module may employ random number generators. The random number generator may be an approved random number generator as, for example, listed in FIPS PUB 140-2, including revisions.

The data input device 230 may be the unit provided in step 213 as discussed in relation to FIG. 2a. The data input device 230 may be used for any of the functions as discussed with reference to FIG. 2a. The data input device 230 may include a housing. The housing may be constructed such that any tampering with the unit by accessing internal components may be detectable. For example, the housing of the data input device 230 may be constructed in a way that special tools are needed to open the housing and opening the housing without the special tools may result in marks or damage to the housing that may be detectable and serve as an indication of possible tampering with the internal components of the data input device 230. For example, special tape may be placed between housing sections such that if the tape is removed, it is damaged in a detectable way. Other known appropriate techniques of making a housing tamper resistant may be utilized.

The data input device 230 may include one or more sensors 232. The sensors 232 may be operable to sense external information 231. The external information 231 may be in the form of audio information, visual information, or any other appropriate type of information capable of being sensed by the sensor 232. The sensors 232 may comprise a microphone capable of converting acoustic energy to electrical signals and a charge coupled device (CCD) capable of converting light energy to electrical signals. The electrical signals may then be encoded. Thusly, the data input device 230 with such sensors 232 may be operable to sense visual and audio information.

The data input device 230 may include a data flow generator 233. The data flow generator 233 may be operable to produce an output that may be combined with other data (e.g., output from the sensors 232) in such a way that the data is watermarked. For example, the data flow generator 233 may be operable to generate an output that comprises a numeric sequence that may be merged with data from the sensors 232, thus producing the watermarked data. The watermarking, as described above, may alter the sensed data in such a way that the sensed data is still usable and accessible. However, the third-party service provider 201 that may have supplied the data flow generator 233 and the corresponding numeric sequence may be capable of analyzing the altered sensed data and determining if any of the data has been tampered with since its watermarking. This may be achieved by examining the watermarked data for the expected alterations. A gap in the expected alterations or an out of sequence or unexpected alteration may be an indication that the data has been tampered with.

The data flow generator 233 may be operable to generate other types of output signals for combination with the data from the sensors 232. For example, the data flow generator 233 may be operable to generate one or more of an alphabetical sequence, and alphanumeric sequence, a sound pulse, an intermittent sound pulse, a data pulse, and an intermittent data pulse. The output of the data flow generator 233 may include time on/off periods. These periods may be produced at regular intervals or at variable intervals. Any intermittent output of the data flow generator 233 may be intermittent at regular intervals or at variable intervals.

The output of the sensors 232 and the output of the data flow generator 233 may flow to a data combiner 235. The data combiner 235 may be operable to combine the output of the sensors 232 with the output of the data flow generator 233 to watermark the data from the sensors 232. The data combiner 235 may include a processor. The data combiner 235 may be capable of encrypting the data. The output of the data combiner 235 (e.g., watermarked data) may be transferred to a data storage device 237. The data storage device 237 may be a memory unit of any appropriate type. For example, the data storage device 237 may be a hard drive and/or a solid-state memory device (e.g., RAM, removable memory card).

Data from the data storage device 237 and/or data directly from the output of the data combiner 235 may be directed to one or more data output devices 238. The data output devices 238 may include, for example, a video display, a speaker, a hard-wired interface (e.g., USB connector), and/or a wireless transmitter (e.g., via a cellular phone network and/or a Wi-Fi network). The video display and speaker may be used to view data stored in the data storage device 237. The wireless transmitter and/or hard wired interface may be used to download the data to a remote location and/or device.

The above description of the components of the data input device 230 of FIG. 2B represent a basic configuration of the data input device 230. As described below, many of the above-described components may include additional and/or alternate capabilities. Furthermore, input device 230 may include additional components and/or futures as described below.

The sensors 232 may comprise more than one CCD. For example, a first CCD may be operable to record visual information in a manner similar to a typical camcorder. In this regard, a user may point a lens interconnected to the CCD at an area to be recorded and may verify the scene being recorded by looking at a display located on the data input device 230 (e.g., a display of the data output device 238). In the present example, a second CCD may be oriented to capture an image of the user as the user captures images with the first CCD. In this regard, the user capturing the images with the first CCD may be identified. Additionally, any remarks or actions of the user while recording a scene with the first CCD may be captured. In the current example, a single microphone may capture audio information of the scene and any comments made by the user while recording. Alternatively, two or more microphones may be utilized.

The sensors 232 may include sensing capabilities other than image and sound capturing. For example, the sensors 232 may include the ability to measure a local temperature. As with other sensed information, output from a temperature sensor may be combined with data from the data flow generator 233 to produce watermarked and/or encrypted data. Temperature and other local sensed conditions may be beneficial, for example, when the data input device 230 is used to record an accident scene.

The data flow generator 233 may be a module within the data input device 230. In this regard, the data flow generator 233 may, for example, be on a separate chipset or integrated into another chipset within the data input device 230. Alternatively, a data flow generator 234 may be a stand-alone device capable of being plugged into the data input device 230. For example, the data flow generator 234 may include a housing and a connector. The connector may be operable to plug into the data input device 230 and supply a flow of data to the data combiner 235. The housing of the data flow generator 234 may be constructed in a tamper resistant manner similar to as discussed above with respect to the housing of the data input device 230.

In another example, the data flow generator 234 may be operable to output and an acoustic signal. The data flow generator 234 may be located proximate to a microphone (e.g., a microphone as part of the sensors 232) so that the acoustic signal output of the data flow generator 234 may be sensed by the sensors 232 and in this manner be combined with the external information 231. In such a system, the data-combining step performed by the data combiner 235 may be unnecessary. The acoustic signal may be within or not within an audible range of frequencies. It is preferred that the acoustic signal be at a frequency that can be sensed by the sensors 232.

The data flow generator 233 may be preloaded and/or preconfigured to produce a particular signal for combination with data to produce watermarked data. Alternatively, the data flow generator 233 may be operable to receive a particular data stream from a remote location. For example, upon activation the data flow generator 233 may communicate with an external source and receive a particular data string, which may then be outputted to the data combiner 235. The external source may, for example, be controlled by the third party service provider 201.

The data flow generator 233 may be operable to be remotely activated. For example, a third party service provider 201 may be capable of remotely activated to the data flow generator 233. This may be done at the request of the user of the data input device 230.

The data flow generator 233 may include the ability to incorporate a current time into the data stream that it produces. In this regard, the watermarking may include information as to the time of the combination. It will be appreciated that any appropriate feature of the output of the internally connected data flow generator 233 may also be present on the externally connected data flow generator 234 and vice versa.

In an alternate embodiment of the data input device 230, the data input device 230 may not include a data flow generator 233 or a data combiner 235. In such an embodiment, the data import device 230 may simply sense local conditions with the sensors 232 (e.g., audio and/or video) and output this data via the data output device 238 to a remote location. For example, the data input device 230 may make a visual and audio recording of a scene and immediately send this to a remote location via a cellular connection. A data combiner at the remote location may then combine the received recording with data from a data flow generator to produce watermarked data.

The data input device 203 may include the optional data storage device 237. The data storage device 237, if present, may be of any appropriate configuration. By way of example, the data storage device 237 may be at least one of a hard drive, a removable hard drive, a CD, a DVD, a flash memory card, a memory stick, a USB flash drive, and digital video tape (e.g., MiniDV). The data storage device 237 may be permanently interconnected to the data input device 230 or the data storage device 237 may be removable from the data input device 230.

The data input device 203 may include the ability to receive external data 236. The external data 236 may be received through an interface such as a hard-wired interface, and/or a wireless transmitter. The external data 236 may be received by inserting a removable data storage device into the data input device 230 and downloading the external data 236 to the data input device. The external data 236 may be handled in a manner similar to the external information 231 described above. In this regard, the external data 236 may be watermarked and/or encrypted by the data input device 230. The external data 236 may be forwarded to a remote location for storage, watermarking and/or encryption. The external data may be a computer file, an email message, a scanned document, or any other appropriate type of data file.

The data input device 230 may further include one or more input devices 239. The input devices 239 may be used to input commands, information, or any other appropriate data into the data input device 230. For example, the input devices 239 may include an electronic signature capture device (e.g., a signature recording pad) operable to record and digitize a signature. As noted herein, this may be used to signify the agreement of a party to conditions displayed by the data input device 230 (e.g., during a transfer of cargo). For example, the input devices 239 may include a numeric keypad and/or a keyboard, which may be used to enter instructions and/or information into the data input device. The input devices 239 may include a touch screen, a document scanner, a magnetic strip reader (e.g., operable to read credit cards, smart cards, and/or identification cards), a barcode scanner, and/or a fingerprint reader. The input devices 239 may include an antenna to receive external commands/information as described above. The input devices 239 may include a GPS receiver capable of determining time and/or location information to be used in the watermarking and/or encryption processes described herein.

The data input device 230 as described herein may be a stand-alone device or the functionality described herein may be integrated into other devices. For example, any or all of the features of the data input device 230 as described herein may be integrated into a cellular phone, a walkie-talkie, a PDA, a GPS receiver, or any other appropriate device or combination of devices. The device in which the data input device 230 is integrated may be portable or it may be fixedly interconnected to a vehicle or structure.

The data input device 230 may include one or more processors that may control one or more of the devices and/or functions of the data input device 230. Furthermore, the processor may perform additional functions such as and identity verification functions. For example, the data input device may be capable of face recognition, voice recognition, and/or fingerprint recognition. In this regard, visual, audio, or fingerprint data may be inputted into the data input device 230 and compared to data stored within the data input device 230 to determine the identity of a party. Alternatively, or in addition, face, voice, and/or fingerprint data may be forwarded (e.g., via the data output device 238) to an external system for recognition.

The various features, components, and functions described with respect to the data input device 230 may be included or not included in any particular data input device. For example, a particular data input device 230 may only be capable of watermarking and recording video and audio information to a DVD. The information on the DVD may then be transferred to another system or the DVD may be stored until needed.

Various exemplary uses of the data input device 230 will now be described. Features and uses described herein in connection with a particular example may be utilized by other examples.

### EXAMPLE 1

### Use of the Data Input Device 230 to Document an Accident Investigation

An investigator may arrive at an accident scene and employ a data input device 230 to document the scene. The accident may, for example, be a traffic accident and/or a hazardous material spill. To document the scene, the investigator may power up the data input device 230 and input any desired settings (e.g., turn on watermarking of recorded data). The investigator may then operate the data input device 230 in a fashion similar to a video camera, recording video and audio of the accident scene. The data input device 230 may watermark the recorded data as it is being written to the data storage module 237 within the data input device 230. The watermarking may be accomplished by combining a signal or signals from a CCD and/or microphone within the data input device 230 with a signal or signals from the data flow generator 233. In another implementation, a processor within the data input device 230 may watermark the recorded data as it is being written to the data storage module 237. In addition to the watermarking or in place of the watermarking, the data may be encrypted. The encryption may be accomplished in any appropriate manner such as those previously described.

The investigator may also interview and/or capture images of individuals at the accident scene. The images may be used to identify witnesses and/or parties involved in the accident. The interviews may contain comments from the individuals regarding the accident. The data input device 230 may simultaneously capture images of the investigator and the other parties as the other parties are interviewed and/or recorded. In this regard, the data input device 230 may include 2 video cameras situated to capture video of the user of the data input device 230 and of the subject being recorded by the user simultaneously. The investigator may also use the data input device 230 to capture images of pertinent documents, such as, for example, driver's licenses, insurance cards, and cargo manifests. In one implementation of the data input device 230, the images captured of the user of the data input device 230 may be used to verify the identity of the user and enable other functions of the data input device 230. For example, after the user's identity is verified, access by the user to an external database through the data input device 230 and/or internal memory of the data input device 230 may be granted. Other functions, such as the ability to record and/or transfer data, store information (e.g., information specific to the user such as identification numbers, credit card numbers, and/or bank account numbers), and/or complete transactions, may also be enabled after verification of the identity of the user.

After at least a portion of the investigation of the accident is completed, the watermarked and/or encrypted data may be uploaded to a remote location. The uploading may be via any appropriate method, including, but not limited to, wireless transfer via a cellular phone network, direct connection of the data input device 230 (e.g., via a USB connection) to a computer and/or computer network, or transfer via a removable data storage device (e.g., flash memory, CD, DVD, miniDV, etc.). The remote location may be a centralized storage area controlled by the investigating party (e.g., the insurer 202 or insured 203) or a location controlled by a third party services provider 201.

In the case where the watermarked and/or encrypted data is stored in a centralized storage area controlled by the investigating party, the data may later be used to, for example, communicate to another party the conditions at the accident scene. The data may also be subsequently delivered to the third party services provider 201 for authentication. This may be done in preparation for submission of the data in a legal proceeding.

In an implementation of the current example, the data input device 230 may include the capability to determine the time of a recording in a manner that may not be tampered with or altered by a user of the data input device 230. In this regard, the data input device 230 may be operable to obtain the current time from a tamper resistant internal clock, a local cellular network, a radio signal, and/or the GPS system. The determined time may be recorded and watermarked and/or encrypted along with any other data that is recorded. In this manner, a third party services provider 201 may be capable of verifying the time at which the data input device 230 recorded the data.

In a variation of the current example, the investigator may use a cellular phone or personal data assistant (PDA) with image capturing capabilities (still images and/or video) to document the accident scene. The investigator may plug an external data flow generator 234 into the cell phone or PDA and the recorded data may be watermarked and/or encrypted as described above with reference to the data input device 230. The watermarked and/or encrypted data may be stored locally in the cell phone or PDA or the data may be immediately transmitted to a location remote from the cell phone or PDA.

In yet another variation of the current example, the investigator may use a cellular phone with image capturing capabilities to document the accident scene. The cellular phone may transmit the captured images in real time or near real time to the remote location. Where the investigating party controls the remote location, the transmitted data may be watermarked and/or encrypted and stored for later retrieval and/or authentication. Where the remote location is a third party services provider 201, the third party services provider 201 may log the time of receipt of the data and store the data. The third party services provider 201 may then distribute authenticated copies of the data (e.g., for submission in a legal proceeding).

### EXAMPLE 2

### Use of the Data Input Device 230 to Document Property Transfer

A first party may document the transfer of property (e.g., cargo, packages, etc.) from the first party to a second party using the data input device 230. The first party may use the data input device 230 to record a visual record of the condition of the cargo at the time and/or place of transfer. The visual record may consist of digital video and/or digital still images captured (e.g., in a fashion similar to a video camera) by the first and/or second party with the data input device 230. Audio information (e.g., a narrative accompanying the visual information) may also be recorded with the data input device 230. The data input device 230 may watermark and/or encrypt the recorded data as it is being written to the data storage module 237 within the data input device 230. This may be accomplished in a manner similar to as described in Example 1 above.

The data input device 230 may also be used to verify the identity of individuals involved in the transfer. For example, the data input device 230 may contain data regarding attributes (fingerprints, voice print, identification card data) of the party that is to receive the property and may be used to confirm the identity of the receiving party to the delivering party prior to transferring the property.

The data recorded with the data input device 230 may be displayed to the first and/or second parties and the first and/or second party may be required to confirm that the condition of the property is as shown in the recorded data. For example, the first party may use the data input device 230 to make a visual and audio record of the condition of the property at the time of transfer. The second party may review the recorded information by watching a display on the data input device 230 as the data input device 230 plays back the recorded information. The recorded information may also include images of documents, such as cargo manifests, packing slips or invoices. The second party may then signify their agreement that the information in the data input device 230 accurately portrays the condition of the property. This agreement may, for example, be in the form of a signature (e.g., on an electronic signature capture device of the data input device 230), a verbal affirmation recorded by the data input device 230, a swipe of an identification card through a card reader on the data input device 230, and/or a payment (e.g., a credit card payment). After the transfer of property is completed, the watermarked and/or encrypted data may be handled similarly to the data as described above in Example 1. For example, the data may be uploaded to a remote location.

If a dispute arises regarding the condition of the property at the time of transfer or the terms of the transfer of property, the recorded data may be useful in settling the dispute. For example, the first party may deliver to the second party a copy of the data recorded at the time of transfer including the agreement of the second party (e.g., an agent of the second party) as to the accuracy of the recording. This may lead to a quick settlement of the dispute. If the second party maintains the dispute, the first party may send the data to the third party services provider 201 who may examine the watermark and/or encryption and verify that the data has not been tampered with. The verified data may then be admitted into a legal proceeding (e.g., arbitration, court) as evidence of the condition of the property and/or assent by the second party as to the condition of the property at the time of transfer.

In an instance, the first and second parties may be common carriers and the property may be cargo. In another instance, the data input device 230 may be used to document a transfer of property where a representative of one of the parties is not physically present at the location of the transfer. For example, a data input device 230 may be mounted at any loading or unloading terminal such as an unmanned remote fuel filling terminal (e.g., a remote biodiesel filling/refining station). To access the terminal, the second party may identify him or herself to the data input device 230. After recognizing and approving the identity of the second party, the data input device 230 may allow delivery of goods to and/or from the second party.

In yet another instance, the first party may be a common carrier and the second party may be an end user and/or consumer. For example, the data input device 230 may be used to document the delivery of pharmaceuticals to an end user. The data input device 230 may display to the user dosage instructions, product warnings, and legal obligations (e.g., use restrictions) and record assent to the conditions/information by the user. In an implementation, the pharmaceutical may be a custom formulated pharmaceutical, such as a neuroceutical, formulated for the particular user.

### EXAMPLE 3

### Use of the Data Input Device 230 to Document a Deposition

A first party may document a deposition, testimony, and/or other proceeding using a data input device 230. The first party may use the data input device 230 to record a visual and/or audio record of the deposition (e.g., in a fashion similar to a video camera). The data input device 230 may watermark and/or encrypt the recorded data as it is being written to the data storage module 237 within the data input device 230. This may be accomplished in a manner similar to as described in Example 1 above.

In an implementation, during the deposition, documentary evidence may be entered into the data input device 230. For example, the data input device 230 may be used to capture images of the documentation. For example, the data input device 230 may be interconnected to a document scanner and a digital file of the scanned document may be transferred to the data input device 230. The data input device 230 may watermark and/or encrypt the digital file of the scanned document as it is being transferred to the data input device 230.

After the deposition is completed, the watermarked and/or encrypted data may be handled similarly to the data as described above in Example 1. For example, the data may be uploaded to a remote location.

If the deposition is to be used in a legal proceeding, the first party may send the data to the third party services provider 201 who may examine the watermark and/or encryption and verify that the data has not been tampered with. The verified data may then be admitted into the legal proceeding.

In a variation of the current example, the first party may use a cellular phone with video capturing capabilities to document the deposition. The cellular phone may transmit the captured video in real time or near real time to the remote location. Where the first party controls the remote location, the transmitted data may be watermarked and/or encrypted and stored for later retrieval and/or authentication. Where the remote location is a third party services provider 201, the third party services provider 201 may store the data. The third party services provider 201 may then distribute authenticated copies of the data (e.g., for submission in a legal proceeding). Appropriate methods of time stamping the data discussed herein may be used to verify the time of the recording of the deposition.

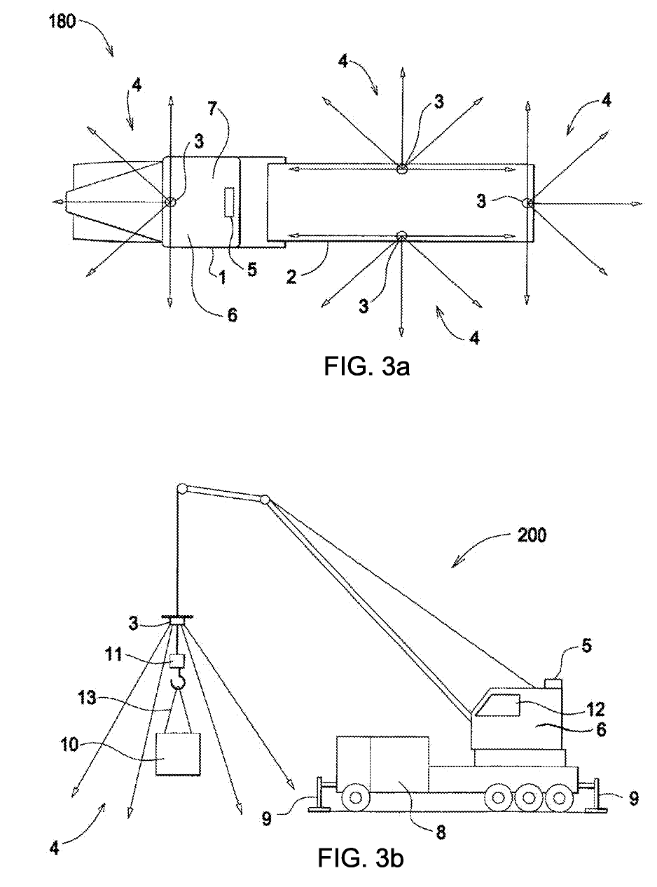

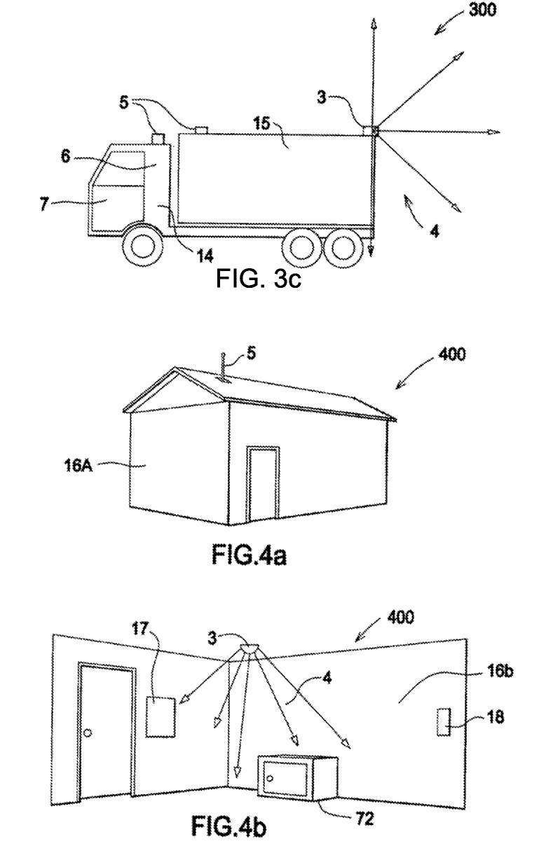

FIGS. 3a-4b are schematic diagrams of embodiments of documentation systems and means taught herein. FIG. 3a is a top view of a trucking application embodiment 180. The top view of power unit (semi-tractor) 1 and trailer 2 shows possible locations for camera(s) 3 and respective fields of view 4 of camera(s) 3. Camera(s) 3 may be capable of fields of view 4 of up to 360° depending on the application desired. Signal transceiver 5 may be located on top of the truck cab of power unit 1 or in any other appropriate position. Signal transceiver 5 is a device capable of transmitting and receiving data to/from a remote location and may be connected to a CPU 6 (Central Processing Unit/Data Recorder). CPU 6 may be located in the cab of the power unit 1 (and/or at a remote location) or in any other appropriate position. On-board controls 7 may also be located in the cab of power unit 1 or in any other appropriate position.

FIG. 3b is a side view of crane and rigging application embodiment 200. The side view of a crane unit 8 with outrigger supports 9 shows cargo 10 being maneuvered. Possible locations for camera(s) 3 and respective field(s) of view 4 of camera(s) 3 are illustrated. One possible location for a camera 3 is just above crane hook assembly 11 for possible view of cargo 10 and rigging 13. Camera(s) 3 may be capable of fields of view 4 of up to 360° depending on the application desired. On top of the cab of crane control center 12 may be signal transceiver 5, which may be connected to the CPU located in the cab (and/or a remote location) of crane control center 12. The on-board controls may also be located in the cab of the crane control center 12. As with the trucking application embodiment 180 of FIG. 3a, the various components may be located in any appropriate location.

FIG. 3c is a side view of intermodal/ocean cargo application embodiment 300. The side view of flatbed truck 14 shows cargo container 15 secure on the bed of the truck 14. Possible locations for camera(s) 3 and the respective field(s) of view 4 of camera(s) 3 are illustrated. Camera(s) 3 may be capable of fields of view 4 of up to 360° depending on the application desired. Signal transceiver 5 may be located on top of the cab of flatbed truck 14 and/or on top of cargo container 15. Signal transceiver 5 may be connected to CPU 6, which may be located in the cab of flatbed truck 14. On-board controls 7 may be located in the cab of the flatbed truck 14. Again, as with the previous embodiments, the various components may be located in any appropriate location.

FIGS. 4a and 4b are exterior and interior perspectives respectively of commercial/industrial/residential real estate application embodiment 400. FIG. 4b is a side view of a structure 16b showing the location of security alarm panel 17. By way of example and not limitation, safe 72 may be secured. Possible locations for camera(s) 3 and respective field(s) of view 4 of camera(s) 3 are also illustrated. Camera(s) 3 may be capable of fields of view 4 of up to 360° depending on the application desired.

FIG. 4a shows an exterior perspective view of structure 16a. Signal transceiver 5, which may be in communication with a security monitoring firm, may be located on top or in the attic of structure 16a. Signal transceiver 5 may be connected to CPU 18. CPU 18 may be incorporated into the security alarm panel 17 or may be a stand-alone device.

FIG. 5a is a system representation of embodiments of Cargo Protection and Controls (CPC), third party verification, and data information flow. It should be understood that a plurality of embodiments are possible which may comprise some, all, or none of the elements of FIG. 5a. Additionally, an embodiment may comprise a single or multiple occurrence of a given element.

FIG. 5a illustrates various types of hardware units and processes. Some may have one way flow while others may have two way flow as will be noted. Data from units may initially flow into interface 36.

The units may have at least three potential sources of power. External power 20 may come from a vehicle or other mobile source or a fixed power distribution or generation system. Solar panel 22 may be used as a primary or secondary source of power. Also, battery 21 may be used as a primary or redundant backup source of power and may be recharged via external power source 20 or solar panel 22.

The following units may have a one way data/energy flow into interface 36: battery 21, camera 3, on-site panic button 34, any additional input unit 23, impact sensor 25, angle sensor 26, temperature sensor 27, flow sensor 28, pressure sensor 29, atmospheric sensor 30, audio input recorder 31, date and time stamp 48, and/or input from medical devices 32. The following units may have a one way data flow received from interface 36: any additional output unit 24 (which may be controlled by switch 47), mace or disabling substance dispenser 37, fire extinguishing device 38, camera monitoring device 41, and/or audio device 42. Any of the aforementioned one-way flow devices may include two-way flow capabilities. For example, the sensors may include remote calibration and/or remotely activated self test routines, and the output units may include status feedback. The following may have 2-way data flow with interface 36: transceiver 5, on-site CPU 6, GPS unit 33, external command panic button 35, encoding device 39, decoding device 40, and/or delivery, control and acknowledgement (DCA) device 60.

Video images may travel from respective camera 3, to interface 36 and onto on-site CPU 6. When appropriate, the images may be encoded 39 and/or encrypted 44 as either stills or as full motion images and saved to recording device 45. Stills or full motion images may be selected based on the occurrence type and user specifications. Also, if programmed, the data may be forwarded 46 on to an external source (e.g., a security monitoring station) for immediate action. Data inputs may flow through interface 36 and into CPU 6 for programmed instructions and/or responses.

Certain commands and/or responses may be issued from external source 19 through transceiver 5, into interface 36 and onto on-site CPU 6. At CPU 6, instructions can be given back through interface 36 to execute various procedures. For example, instructions can be given to utilize audio device 42, introduce a disabling substance into a specified environment 37, and/or kill the ignition 75 (e.g., in the cases of robbery or hijacking). For security reasons, instructions can be encoded 39 at the on site location prior to transmission to off site location 19, and decoded 40 once they arrive back on site.

Should a triggered incident occur, the encrypted data stored in recording device 45 may only be accessible to independent third parties. An independent third party may be a Third Party Service Provider 201 and/or a database storage service bureau, which may be certified to maintain accurate and authentic data by parties such as law enforcement, the judicial system, and other interested parties. By way of example and not of limitation, a party which certifies that a database storage service bureau maintains accurate and authentic data may comprise individuals acceptable to a government law enforcement agency, and/or a judicial agency, and/or an insurance industry trade group.

As noted above, embodiments are possible that may comprise some of the elements of FIG. 5a. FIG. 5b is an illustration of such an embodiment of a system used to document the transfer of property. FIG. 5c is a flow chart showing a process using the system of FIG. 5b.

The first step 510 in the process may be to obtain a unit capable of documenting the transfer of property. The unit may be a property transfer recordation unit 525, as illustrated in FIG. 5b. The elements schematically illustrated in FIG. 5b may all be present in a single portable and/or hand held property transfer recordation unit 525. The property transfer recordation unit 525 may be a unitary device. The property transfer recordation unit 525 may be a data input device as described above.

The property transfer recordation unit 525 may include some or all of the elements of a DCA 60, discussed in detail below. For example, the property transfer recordation unit 525 may include a display 61 (e.g., an LCD display) capable of displaying text and/or visual information such as digital images or digital video. The property transfer recordation unit 525 may also include an audio output device for playing audio information. The property transfer recordation unit 525 may also include an electronic signature spot 64 (e.g., an electronic signature capture device) capable of digitally recording a signature. Furthermore, the property transfer recordation unit 525 may include an alpha keyboard 62 and/or a numeric keyboard 63 for the input of textual and/or numeric information.

The property transfer recordation unit 525 may be operable to be powered by an on board battery 21. The property transfer recordation unit 525 may also include an electrical plug or other interface capable of interfacing with an external power source, such as a standard AC outlet or standard automotive 12 VDC outlet.

The property transfer recordation unit 525 may be capable of recording audio and visual information. For example, the property transfer recordation unit 525 may include a camera 3 capable of capturing digital still images and/or digital video. The property transfer recordation unit 525 may also include an audio input recorder 31 (e.g., a microphone). The property transfer recordation unit 525 may be capable of capturing such visual and or audio information and encoding the information using an encoding device 39. The encoded information may optionally be encrypted by an encryption device 44. The encoded and/or encrypted information may then be stored on a recording device 45. The recording device 45 may, for example, be a hard drive, memory card, on board solid-state memory, or any other appropriate recording media. The recording device 45 may be a fixed component of the property transfer recordation unit 525 or may be a removable component. A CPU 6 may control the various attached devices and/or elements of the property transfer recordation unit 525. The various devices and/or elements of the property transfer recordation unit 525 may be interconnected through an interface 36.

The property transfer recordation unit 525 may also possess GPS capabilities. The GPS capabilities may include a GPS receiver 33. Through the GPS receiver 33, the property transfer recordation unit 525 may be operable to timestamp, using the GPS time reference, the recorded information or any other function performed by the property transfer recordation unit 525. Also through the GPS receiver, the property transfer recordation unit 525 may be operable to record the location of the property transfer recordation unit 525 during any particular operation of the property transfer recordation unit 525, such as visual recording, audio recording, signature recording, or any other appropriate function performed by the property transfer recordation unit 525.

As noted, the property transfer recordation unit 525 may include a removable memory device 45. Accordingly, one method of transferring information from the property transfer recordation unit 525 to another party, such as the Third Party Service Provider 203, may include removing the recording device 45 from the property transfer recordation unit 525 and transferring it to the other party. The property transfer recordation unit 525 may have a transceiver 5 for wireless communication. Accordingly, information may be transferred to and/or from the property transfer recordation unit 525 to other parties via a wireless link enabled by the transceiver 5. The transceiver 5 may be operable to transfer information in one or more of a variety of ways. For example, the transceiver may be operable to interface with a cellular phone network, a satellite network, and/or a wireless computer network. Through the transceiver 5, the property transfer recordation unit 525 may be operable to interface with, and send and receive information across, the Internet. In addition to, or in place of, the transceiver 5, the property transfer recordation unit 525 may have a hard-wired interface (not shown in FIG. 5b). The hard-wired interface may, for example, be an interface capable of interconnecting the property transfer recordation unit 525 to an Ethernet connection, to a computer (e.g., via a USB port), and/or to a telephone network (e.g., via a phone jack).

As described below, the property transfer recordation unit 525 may be capable of encoding and/or encrypting information in such a manner that subsequent tampering with the information may be detectable. The property transfer recordation unit 525 itself may also contain safeguards to allow for detection of tampering. For example, the property transfer recordation unit 525 may be sealed or constructed in such a manner that any unauthorized disassembly or alteration of the property transfer recordation unit 525 may be detectable.

Turning to FIG. 5c, after the step 510 of obtaining the property transfer recordation unit 525, the next step 511 may be to input property related information into the property transfer recordation unit 525. This may be accomplished in a variety of ways. For example, the property related information may be inputted 512 as a textual description of the property. This textual information may be inputted via, for example, the alpha keyboard 62, or it may be downloaded from another source (e.g., via the transceiver 5, through a direct connection, or by inserting a removable recording device 45 that contains the textual information).

In other example, the property related information may be inputted 513 as visual information. This may be accomplished by using the camera 3 of the property transfer recordation unit 525 to capture a visual record. The visual record may include footage (e.g., video footage and/or still images) of the property to be transferred, the environment in which the transfer is taking place, and/or representatives of the parties involved in the transfer of property. Audio information may be inputted 514 in a similar manner and at the same time as the video information.

In yet another example, the property related information may be inputted 515 as a textual description of the proposed relative rights and responsibilities of the parties involved in the transfer of property. For example, the textual description may include language signifying that the party to which the property is being transferred to acknowledges the condition of the property and/or the terms of the transfer. The property related information may be inputted using, and include, any combination of the above-described examples.

The transfer of property may be documented for a variety of reasons. For example, one or more of the parties involved in the transfer of the property may be common carriers and the property transfer recordation unit 525 may perform the function of a manifest. In this regard, the property transfer recordation unit 525 or a portion thereof (e.g. a memory storage device) may accompany the property after it is transferred from a first party to a receiving party. The property may be cargo, for example, contained in a trailer or other shipping container. The property may contain hazardous materials.

Following the step 511 of inputting the property related information into the property transfer recordation unit 525, may be the step 516 of recording a signature of the receiving party with the property transfer recordation unit 525. The signature of the receiving party, as used herein, may include a signature of the receiving party and/or a signature of a representative of the receiving party. The signature of the receiving party may be a single signature or multiple signatures by multiple individuals. Contemporaneously with the recordation of the signature of the receiving party, the next step 517 may be to display information on the display 61 in such a manner that the signature of the receiving party signifies agreement to the contents of the display 61. For example, the display may show a picture of the property to be transferred and the signature of the receiving party may represent the receiving party's agreement that the picture accurately describes the condition of the property at the time of signature. For example, step 518 may include having the display show a textual description of the property and the signature of the receiving party may represent the receiving party's agreement that the textual representation accurately describes the condition of the property at the time of the signature. For example, the display may show terms and conditions of the transfer of property including an acknowledgment of the responsibilities of the receiving party with respect to the property and the signature of the receiving party may represent the receiving party's agreement to those terms and conditions.

Contemporaneously with, or shortly thereafter, the recordation of the signature of the receiving party, the property transfer recordation unit 525 may perform the step 519 of associating the signature with the displayed information. In this regard, the signature of the receiving party and the displayed information may be linked together in such a manner that it is discernible what the receiving party was agreeing to through the receiving party's signing. This is analogous to a signature on a written contract wherein the signature represents a party's agreement to the terms printed on the contract.

Contemporaneously with, or shortly thereafter, the recordation of the signature of the receiving party, the property transfer recordation unit 525 may perform the step 520 of encoding the signature and the displayed information. This encoding may be performed in such a manner that subsequent tampering with the encoded information may be detectable. For example, the encoding may watermark the information in such a manner that subsequent tampering with the watermarked information may be detectable. The encoding may include encrypting the information to limit access to the information to specific parties.

After encoding, the next step 521 may be to digitally store the signature and displayed information. This storage may be on the recording device 45 of the property transfer recordation unit 525.

After storing the information, the next step 522 may be to transmit the encoded signature and displayed information. As noted earlier, this transmission may be a wireless transmission from the property transfer recordation unit 525. The transmission may also be in the form of removing the recording device 45 from the property transfer recordation unit 525 and delivering the recording device 45 to another party. The transmission of the encoded signature and displayed information may be from the property transfer recordation unit 525 to a data storage point. The data storage point may be under the control of the first party and may be archived in case it is required at a later point in time (e.g. to verify the condition of the property at the time of the transfer of the property in a legal proceeding). The data storage point may be controlled by the Third Party Service Provider 201 who may archive the information until it is required at a later point in time.

If, subsequent to the transfer of property, a potential claim arises in which the condition of the property at the time of the transfer of the property is relevant, the Third Party Service Provider 201 may perform the step 523 of verifying that the signature and other information have not been tampered with or altered since their original recording. The Third Party Service Provider 201 may then produce certified recordings of the signature and displayed information for distribution to the various parties involved and/or for submission as evidence in a legal proceeding.

By way of specific example of the use of the property transfer recordation unit 525 to document the transfer of property, the following scenario of the transfer of cargo from a first common carrier to a second common carrier is described. The first common carrier may deliver the cargo to a predetermined location for transfer to the second common carrier. At the location, the first common carrier may use the property transfer recordation unit 525 to visually document the condition of the cargo at that point in time. The visual documentation may include digital video footage of the cargo along with still digital images captured by the first common carrier using the property transfer recordation unit 525. The first common carrier may then present the property transfer recordation unit 525 to the second common carrier for signature. The second common carrier may review the visual documentation along with textual information displayed on the property transfer recordation unit 525 stating that a signature by the second common carrier acknowledges the condition of the cargo and the accuracy of the visual documentation. The signature, along with the visual documentation, may be encoded and encrypted by the property transfer recordation unit 525. A copy of the encoded and encrypted information may be transmitted to any of the parties involved (e.g. the first common carrier, the second common carrier, or the Third Party Service Provider 201 who provided the property transfer recordation unit 525). The second common carrier may then take the property transfer recordation unit 525 and the cargo and continue the delivery process of the cargo. The second common carrier may, for example, deliver the cargo to its ultimate destination or it may transfer the cargo to a third common carrier. If, at a later point in time, a dispute arises regarding the condition of the cargo at the time of the transfer between the first common carrier and the second common carrier, the signature and video documentation may be verified by the Third Party Service Provider 201 and a certified copy of the signature and visual documentation may be forwarded to any of the parties as appropriate. The signature and visual documentation may also be entered as evidence into any legal proceeding that may occur where the condition of the cargo at the time of the transfer from the first common carrier to the second common carrier is relevant.

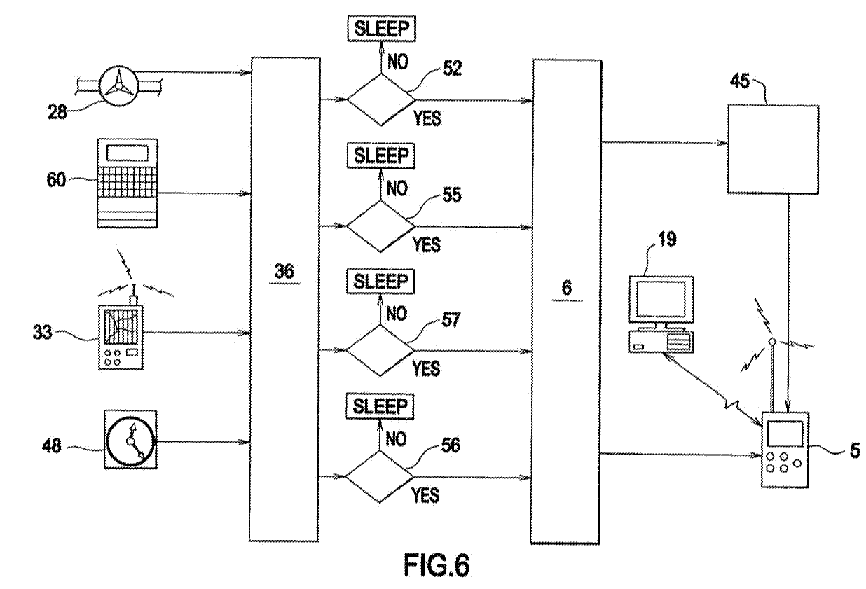

FIG. 6 is a system representation of sensor data and other device input as well as other device input to CPU 6. Flow data from flow sensor 28, or data from another sensor, may go into interface 36 when activated 52. At all other times, sensors may be in sleep mode to save energy. Data may flow from interface 36 to on-site CPU 6 and if programmed, onto recording device 45. Data may further flow onto external control center 19 via transceiver 5.

In the event Delivery/Control/Acknowledgement DCA unit 60 is activated 55 and/or GPS 33 is activated 57, the same procedure discussed above with respect to flow sensor 28 may be followed. For the purpose of this illustration, clock 48 is shown to represent the time/date stamp that may be attached to some or all data when activated 56. However, the time/date stamp function may be provided by hardware and/or software in CPU 6 at the time of data transfer from interface 36 to CPU 6.

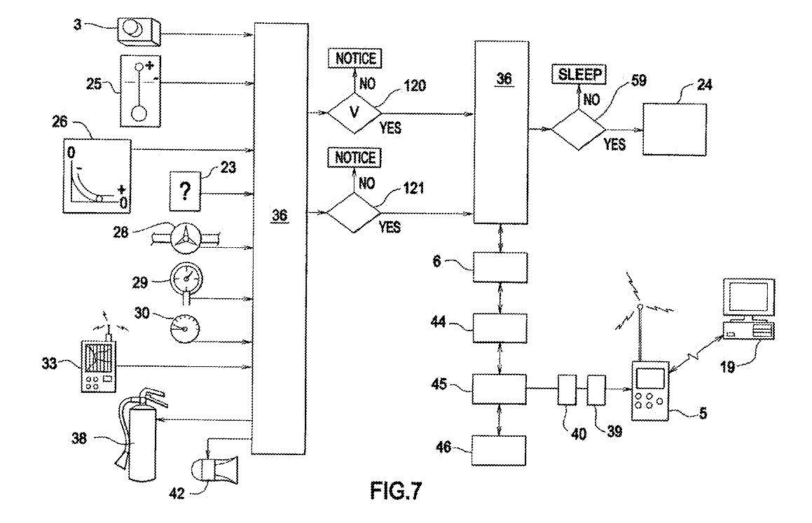

FIG. 7 is a system representation of data flow with third party verification (e.g., by a Third Party Service Provider 201). At activation, camera 3 images, if not digital may be converted to digital format. If the images are not corrupt, they may be sent to CPU 6. The images may be encrypted 44 and then sent onto recording device 45. The images may further be sent to external control center 19 via transceiver 5 after optional encryption 44 and encoding 39. External control center 19 may further review the images, analyze the images, and/or respond to the images in the form of command requests. If the images are corrupt, a malfunction notice may be sent to the appropriate party.

At activation of any sensor (e.g., 3, 25, 26, 28, 29, or 30) or any additional device 23 that requires an action be taken, recorded, or transmitted, the camera image 120 or data information 121 may be converted to appropriate signal quality. If the data is not corrupt, it may be sent to CPU 6. The data may be encrypted 44 and then sent onto recording device 45. The data may further be sent to external control center 19 via transceiver 5 after optional encoding 39. External control center 19 may further review the data, analyze the data, and/or respond to the data in the form of command requests. If the data is corrupt, a malfunction notice may be sent to the appropriate party. Individuals and/or systems at external control center 19 may send commands via transceiver 5 within their directives and authority if in their discretion they believe action is required based on information received from the site via transceiver 5. The commands may then be decoded 40 and sent on to CPU 6. The instructions may then be given to the various output devices via interface 36 and appropriate action may be taken (e.g., sounding horn 42, activating fire extinguishing device 38).

The following is an example of a possible embodiment of a system for documenting a loss in a vehicle or involving a vehicle. Such embodiment is referred to as a TR-ED (Time Recording and Encoding Device). It is to be understood that the following embodiment is offered solely by way of example and not of limitation. Various other embodiments of a system for documenting a loss in a vehicle or involving a vehicle are possible.

A small, easily installed video capture device may be installed inside the cab of a vehicle or other equipment. It thus provides a real time recording and encoding system. The fixed, forward facing camera will provide a view of the road consistent with that of the operator's field of view, which is the vehicle's trajectory. An on-board digital video recorder will continually “loop” the live video shot to its hard drive, only maintaining that video signal upon activation of a “go” sequence. The “go” sequence may be any one of multiple events that take place within the vehicle or an incoming signal to the vehicle via wireless communication (e.g., satellite communication). This process will secure a desired real-time video of an incident in the system's on board memory for future analysis by an Authorized Third Party (ATP) (e.g., Third Party Service Provider 201). A key to this embodiment's performance is that the device must be small enough not to impede the driver's or operator's field-of-view when installed inside the vehicle or other equipment (glass, visor, dash, etc.). Specific considerations will be given to its current consumption, operating voltage (e.g., 6 VDC-30 VDC), and ease of installation. It is understood that there may be a wide range of operating protocol for the device including: continuous operation, vehicle-on operation, remote-on operation, etc. Consideration will be provided during design for various “on/off” scenarios. The physical characteristics of the device must be rugged enough to provide protection from: vehicle accident, shock, extreme heat and cold (−60° F. to +200° F.), water, and fire. An internal battery backup may be provided with duration sufficient to continue the post-alarm in the event of battery termination resulting from impact, fire, or other event.

The system may run a “go” sequence consisting of pre and post alarm duration. The system may continuously record activity in loop increments (duration to be discussed later). Following the activation of the “loop start” function, the unit will continue to record for a 50% interval, then archive the incident file in its entirety.

Versions of the device can include: a fixed interval-single event system (FISE); a variable interval-single event system (VISE); and a variable interval-multiple event system (VIMS).

A. FISE: documents a single event upon activation of the “go” sequence. The continual twenty (20) minute loop will save ten (10) minutes from the pre-alarm and continue to run for ten (10) minutes from the post-alarm. If the video monitoring subsystem is disabled by the occurrence, then all of the storage subsystem memory (nominally 20 minutes) may be used to store pre-event data.

B. VISE: documents a single event upon activation of the “go” sequence. The user selectable duration of ten (10) minutes to sixty (60) minutes can be programmed into the non-volatile memory prior to deployment of the device, and will perform similar to the FISE after activation.

C. VIMS: documents multiple events upon activation of the “go” sequence. The system will program and perform similar to VISE, with the added benefit of logging multiple events as files on the hard-drive (the actual number of events and duration will depend on duration of each respective “go” sequence). While running a documentation sequence, the VIMS will ignore additional commands to activate the “go” sequence. Only at the conclusion of a respective sequence will the device accept an additional “go” command.

Multiple “stop” mechanisms for activation of “loop start” recording may include the following: an accelerometer (or alternate method of determining acceleration, deceleration or directional change outside a vehicle's or equipment's normal operating characteristics), a manual “Emergency Stop” pushbutton for operation by a driver or an operator, a satellite communication protocol, etc.

A variable-frame-rate (VFR) compensation system can be integrated into the device by its internal software system in an effort to conserve storage space and provide optimum image quality at the time of incident. Using a software enabled pre-event alarm sequence, the system will automatically recall and save images, for example, five seconds prior to a stop sequence at a rate of up to about 30 frames-per-second (fps). The system will continue to conserve five seconds following the stop event at this high-resolution, then return to a slower rate (e.g., five frames per second). The ramp-up frame rate during an incident will dramatically improve the possibility for positive vehicle or equipment identifying information (e.g., license plate) gathering during the critical prior and post incident seconds. Changes in timing can easily be programmed.

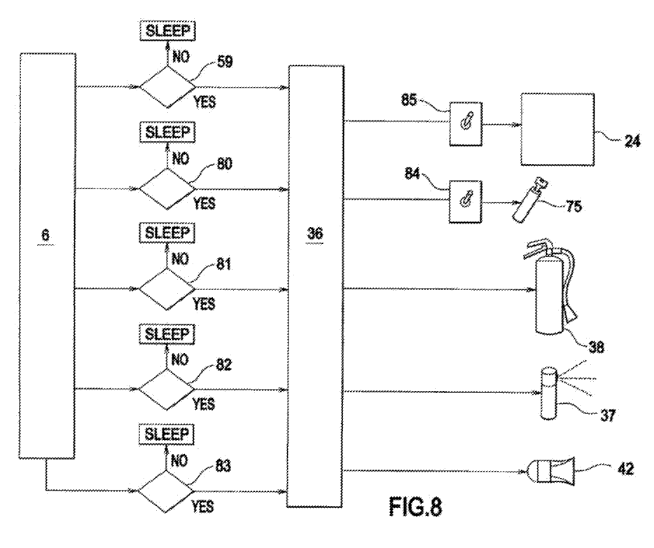

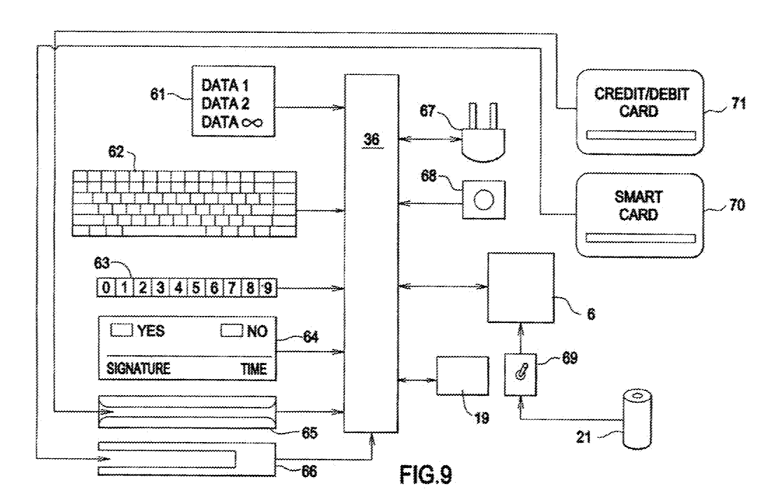

FIG. 8 is schematic representation of potential actions that may be taken as the result of an occurrence. FIG. 8 expands on the description of FIG. 7. Once a command arrives back on site and is in CPU 6, the go order may arrive at interface 36 and the appropriate action sequence may be initiated. By way of example and not of limitation, an appropriate action sequence may comprise one or more of the following: vehicle ignition termination 80 through off/on switch 84 disabling ignition 75 via remote panic button protocol 35 (shown in FIG. 5a), fire extinguishing commences 81 using associated device 38, release of disabling substance 82 begins per use of device 37, noise 83 is used through horn or siren 42, or activation/deactivation 59 or other action is commenced 85 using any other output unit 24.

FIG. 9 is a schematic description of DCA 60, which may include a remote data entry system for cargo identification, acceptance/rejection verification, payment input, and various smart card functionalities. The DCA 60 may be a hand held device that verifies the delivery, control, and acknowledgement of the receipt of cargo. The DCA 60 may also accept credit card 71 payment 65 and any data input from a smart card 70. Data from smart card 70 may be used to complete the delivery, identify the sending and/or receiving party or transfer the cargo to another shipper for final delivery. The DCA 60 may also be connected to Interface 36 directly through the interface connection plug 67 with CPU 6 or an external CPU 19. The DCA 60 may incorporate data input from an alpha key board 62, a numeric keyboard 63, an electronic signature and order spot 64 (e.g., an electronic signature capture device) for acceptance or rejection of the order 64, and/or a credit card payment swipe 65. The DCA 60 may transfer the information recorded in a smart card 70 into a database through the smart card insert 66. This input information, along with any other information regarding the cargo from the internal CPU 6 and/or an external CPU 19, may be displayed for customer verification in LCD display 61. The displayed information may then be acknowledged by the recipient and the transaction may be verified and tracked for third party (e.g., Third Party Service Provider 201) verification by activation of the final verification acknowledgement indicator 68. The DCA 60 may be powered by internal battery 21 via switch 69.

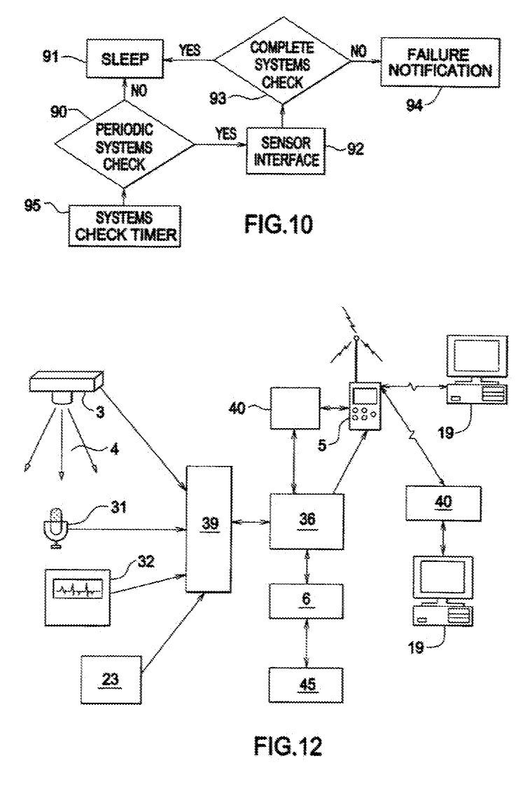

FIG. 10 is a flow chart of the CPC systems checks. FIG. 10 describes the flow of system checks internal to the system that may be performed on site or remotely. These checks are designed to verify functionality of individual units on a regular basis so as to correct problems prior to any possible incident/occurrence or allow the replacement of the units as necessary. Additionally, the CPC systems checks may notify an administrator at once in the event of any malfunction. Timer 95 can optionally enable periodic system check 90 to run, or system check 90 can have programmable activation. Periodic system check 90 may run periodic diagnostics. If activated, the system monitors sensor interface 92. A complete system check 93 may then performed. If the result of the check is “OK” (yes), a return may be done into sleep mode 91. If not, a cause failure notification 94 may be sent to the system monitor.

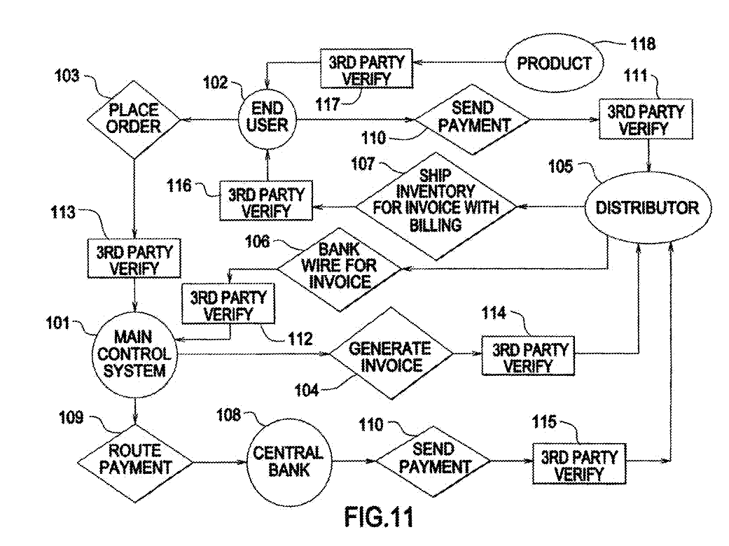

FIG. 11 is a flow diagram of an embodiment showing loss control procedures. An end user 102 places an order 103 into a main control system 101. The order is verified 113 by a third party. Main control system 101 then generates invoice 104, which is verified 114 by a third party, and sent to distributor 105. Distributor 105 ships inventory, which is verified 116 by a third party, along with an invoice for billing 107, to end user 102. End user 102 then sends payment 110, which is verified 111 by a third party, to distributor 105. Once payment 110 is received by distributor 105 and verified 115 by a third party, bank wire 106 is verified 112 and sent to main control system 101 which routes payment 109 to central bank 108. End user 102 receives product 118, which is verified 117 by a third party.

FIG. 11 thus illustrates a basic distribution/tracking model or system of secure components that form an integrated solution to the problem of third party compliance for tracking. The system may track goods and data such as manufactured goods, percentage of completion of construction projects, completed construction projects, purchase agreements/contracts, services and/or associated products. For example, a third party (e.g., a specified agent not associated with any manufacturer, distributor, or contractor) will provide hosting and maintenance of a server facilitating tracking. A security certification agency not associated with the hosting agent, manufacturers, distributors, and/or contractors may ensure transaction security between manufacturers, distributors, and/or contractors through the issuance of a security certificate reviewed and renewed annually. In the case of manufactured products, an E-commerce infrastructure may have a custom database design and implementation for the storage of information relating to the tracking of manufacturer's products, shipping tracking information, and distributor's receipt of goods. A database may also track purchase orders and receipt of payments for exportation to other software products (e.g., spread sheets). A client software application may facilitate the entry of manufacturing and shipping information for products of manufacturers' clients. The software application also may facilitate the entry of shipping receipts for manufactured goods and the generation of purchase order requests. Software may also be available for a custom design and implementation of infrastructure required for ordering and purchasing a manufacturer's products online via a website.

A Distributor's Web-interface to E-commerce infrastructure may exist as a custom design with a minimum of templates for interfacing with the E-commerce infrastructure. Services for integrating distributor web-interfaces into the E-commerce infrastructure may also exist for support and maintenance of distributor web-interfaces.

FIG. 12 is an example of an embodiment applying third party compliant data and storage to a medical application. This embodiment integrates fields of view 4 images from camera or optical device 3 and audio 31 to a medical profession application. The process may start with the video and audio recording of the pre-surgery interview between a patient and a doctor. The doctor may outline the treatment, operation, expected result(s), and recovery. In the process, the doctor may address all concerns of the patient and releases may be executed. This information may be encoded 39 and stored 45 in a manner referencing the patient's file number or other identification number. During the operation, all video camera and optical device 3 signals, their field of view 4, monitoring equipment 32 signals, and audio 31 signals may be recorded. The data may be encoded 39, transmitted to interface 36, transmitted to central processing unit 6, and then stored 45 in a manner such that it is referenced to the patient's identification number. In the event that the operation is to be viewed live by a group of off-site medical students or consulting physicians, the data can be decoded 40 and transmitted 5 to an off-site CPU 19 for viewing. If the operation requires the assistance or supervision of an off-site doctor who is participating or instructing and/or in the event of an emergency, the encoded data can be sent directly by the transceiver 5, decoded 40, and viewed 19. In the event that patient information needs to be reviewed prior to the operation or included in the third party verified data, the information can be down loaded by involved off-site parties who have permission and are connected through an additional input unit 23. During the patient's recovery or rehabilitation, some or all of the information that may be relevant to that patient's condition such as test results, prescription relief and so forth, may be electronically recorded, encoded, stored, and referenced to the patient's identification number. In the event of complications, the entire file can be accessed to evaluate the treatment and to review the operation and the patient's rehabilitation. In the event of litigation by the patient, the entire file may be admissible as evidence. The encoded copy of the file may be decoded, certified, and forwarded to both sides of the litigation and the court. The fact that the patient's data file is encoded may help insure that the patient's medical history privacy will be maintained. Additionally, the patient's encoded data file may allow a second opinion to be offered from a remote location, may be used as a source of emergency medical data (even if the patient is at a remote location), and may be used to assist the patient with their own records and questions regarding their health.

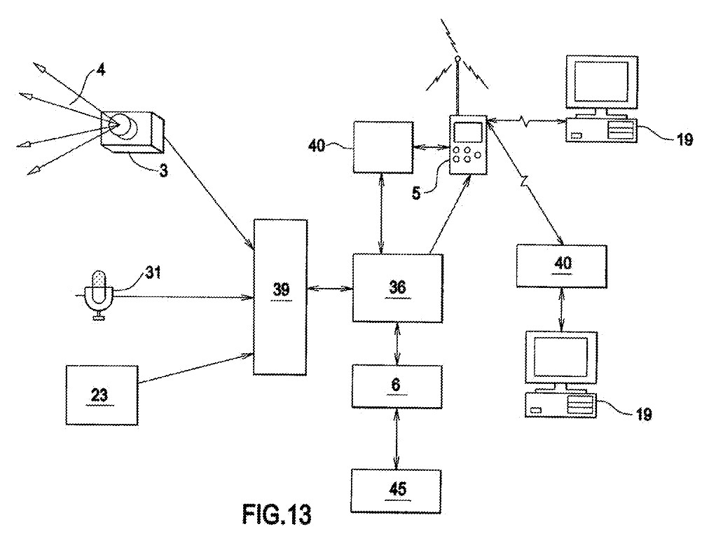

FIG. 13 is an example of an embodiment applying third party compliant data and storage to a legal application. This embodiment integrates fields of view 4 images from camera or optical device 3 and audio 31 to a legal profession application. The current standard for depositions is for legal proceeding data to be transcribed by a court recorder. With the introduction of encoded third party compliant data, the entire deposition can be viewed in real time and/or at a later time. The video image of the deposition, through camera 3, records non-verbal communication in its field of view 4. Audio 31 records all of the off-the-record motions and discussions as well as the on-the-record record motions and discussions. Any pertinent computer generated or scanned documents can be connected through additional unit input 23. The data may be encoded 39, stored 45, and made available to review. Data may be transmitted in real time or at a later time to a remote location via transceiver 5. When data is transmitted to a remote location via transceiver 5, it may be decoded 40 and viewed through CPU 19, or the data may be decoded 40 and transmitted via transceiver 5 to CPU 19 for storage and retrieval at a later date. The set up and compliance to evidentiary standards can be performed by any certified court reporter.

The end result may be one edited copy with the off-the-record motions deleted from both the audio 31 and video field of view 4 signals for court and evidence use. Additionally, a non-edited copy may be provided which includes all video and audio recordings. The non-edited copy may be available to both plaintiff and defense attorneys. In summary, the video and the audio data may be combined in a format that follows federal rules of evidence. It may be encoded to guarantee validity and originality. It may be decoded and certified by an independent, third party (e.g., Third Party Service Provider 201) prior to review by any governmental entity, court system, arbitrator, or other party that requires third party verification of the validity and authenticity of data.

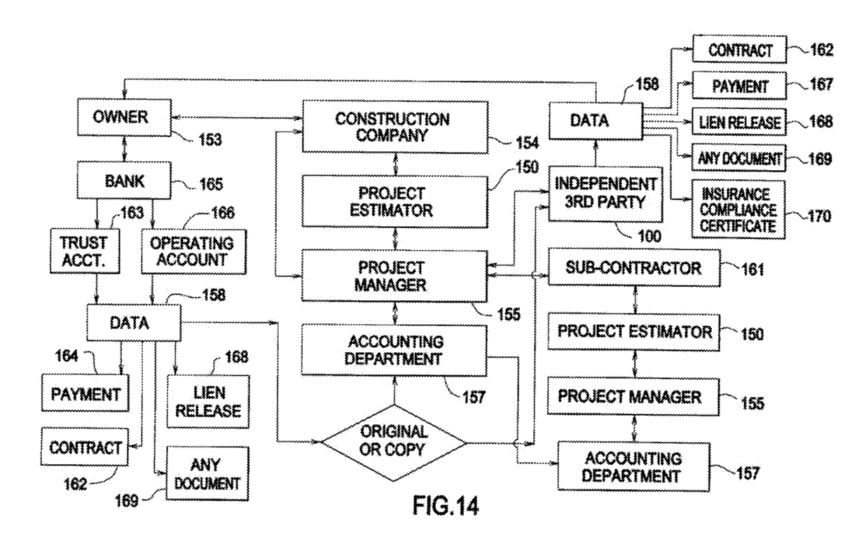

FIG. 14 is an example of an embodiment applying third party compliant data and storage to document a construction project. It is to be understood that the following embodiment is offered as an example and should not be construed as a limitation. An owner awards a contract to a construction company for construction of a project. The contract is the legal framework that sets terms, which may include, but are not limited to, payment requirements, documentation required to substantiate work performed, compliance to codes and regulations, and methods for dispute resolution.

Supervision of the project and contract management is turned over to the project manager of the construction company. The project manager may execute one or more separate contract(s) with subcontractor(s) for work that they will perform. The management of the prime contract and all subcontracts is the responsibility of the project manager, who shares relevant data with parties who have a vested interest in the project. By way of example and not of limitation, such parties may include:

1) Owner(s),

2) Subcontractors,

3) Banks and/or trust departments, and/or

4) Independent Third Parties.

The information to be shared by the project manager may be encoded. It may be shared utilizing proprietary access codes functioning to give particular parties log-on ability to their respective relevant data, which may be updated in real time via the project manager and/or the accounting department. All access may be granted on a permission basis dependent on a party's responsibility to the project. Access may be limited to selected data. Additionally, permission to edit or add to existing data may be given.

Project data may begin to accumulate when the project commences and may continue to amass until project completion. Every transaction involving the project data may be recorded and encoded to provide a virtual paper trail. The project data may be subject to review by various parties based upon their level of permission. By way of example and not of limitation, the data reviewed may be any or all of the following:

1) Pay Request

2) Payment(s)

3) Lien Releases

4) Change Orders

5) Audits and Analysis and Final Adjustments

6) Final approvals(s) and sign-off

7) Warranty

By utilizing a third party tracking and compliance system, all projects may be capable of virtual seamless integration between contract administration, estimating, accounting, and project management, as well as all related contributors, e.g., legal, insurance, surety, banking, etc. This third party integration may enable and enhance independent and verifiable tracking, monitoring, compliance, and audit functions.

In the event of a latent defect, all the encoded and relevant information may be available to the appropriate parties. This is especially important to a surety in the event of a claim made after the completion of the project, but within the warranty period. Parties and/or circumstances contributing to the latent defect can be identified by the independent third party to allow for timely resolution as set out in the contract document(s). Additionally, the third party compliant project data may be admissible as evidence in court.

The following is an illustration of the information flow in a possible embodiment of a method of using a third party compliant data management system to document and track construction management. It is to be understood that other embodiments of using a third party compliant data management system to document and track construction management are possible.

Construction project estimator 150 prepares a cost estimate for construction of the specific project. Owner of the project 153 awards project contract 162 to construction company 154 that employs construction project estimator 150. The direction of the project and contract management is then turned over to project manager 155, who is employed by construction company 154. In turn, project manager 155 executes one or more contract(s) to subcontractor(s) 161 for work they will perform, and is responsible for the management of these contracts and subcontractors. All project information data flows to and through project manager 155.

Project manager 155 confirms all work that has been completed and forwards the information to independent third party 100 for verification. The same information is sent to accounting department 157 to be billed. Once verified, independent third Party 100 prepares a request for payment 167, obtains signed lien releases 168, and forwards them to owner of the project 153. Owner of the project 153 authorizes bank 165 to make payments 164. Depending upon the terms set forth in project contract 162, funds are paid from either operating account 166, or third party trust account 163. A copy of payments 164 is sent to accounting department 157, and independent third party 100.

In some instances, independent third party 100 sends request for payment 167 to owner of the project 153, who then sends lien releases 168 to project manager 155 for signature. When received, a copy is sent to the independent third party 100 and owner of the project 153 who authorizes bank 165 to release payments 164. A copy of payments 164 is sent to accounting department 157 and independent third party 100. Generally, no payments 164 will be made without signed lien releases 168.

As the project progresses, independent third party 100 begins to integrate project information data 158, tracking, contract compliance documents, and any other documents 169 relevant to completion. Independent third party 100 will maintain insurance compliance(s), monitor certificates of insurance, and administer insurance compliance audit programs.

In the case of construction projects, by utilizing the project manager 155 as the hub for all information flow and all job related activity, projects will be capable of virtual seamless integration between contract compliance, estimating, accounting and all related third party contributors. This third party integration will enable and enhance independent and verifiable tracking, compliance and audit tasks.

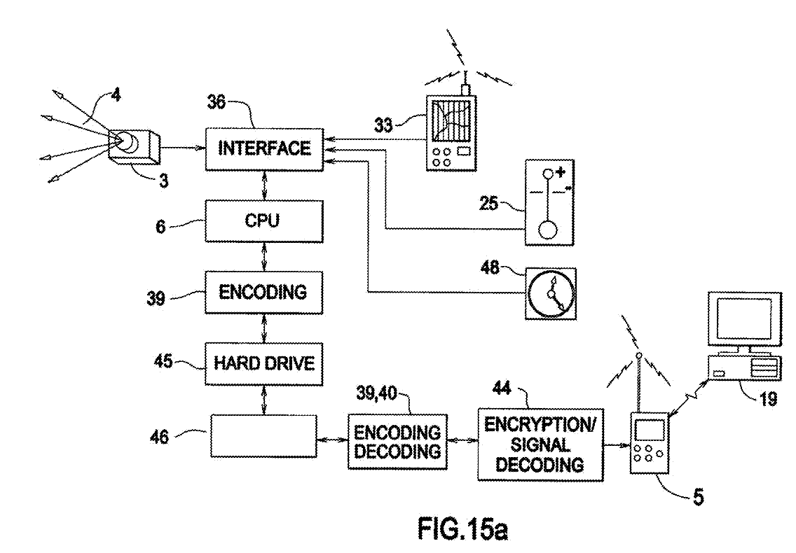

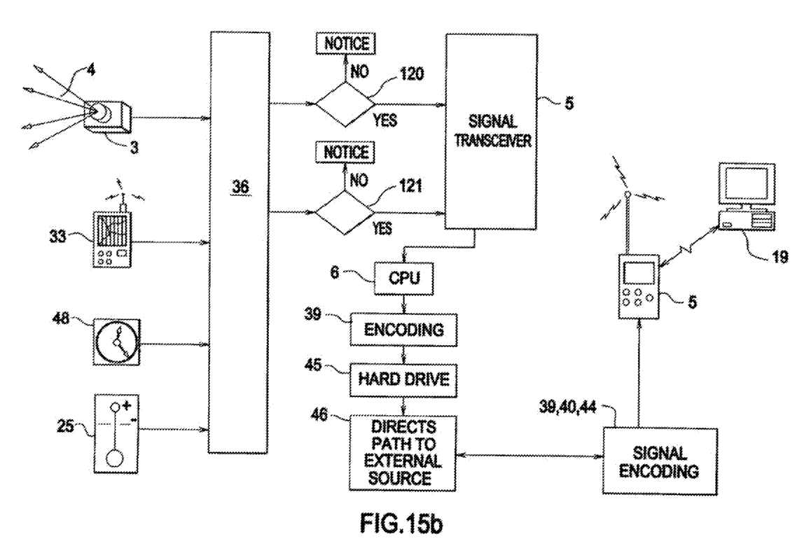

FIG. 15a is an example of an embodiment of a third party compliant data system integrated into a trucking industry application and follows the diagram of FIG. 3a. The system in this example is referred to as a V-RAD unit, and comprises interface 36, camera 3, field of view 4, GPS locator 33, date and time 48, and the impact sensor 25. CPU 6 encodes 39 the data and stores the data in the hard drive 45. The hard drive 45 continuously records the data in a loop until such time as the impact sensor 25 is activated. At that point, data recording device 45 records the encoded data until the data loop has recorded for the specified time in the software program or recording time setting. At any point in time, the encoded data in the hard drive 45 can be downloaded and directed 46 into the encryption transmission signal coding 44, and transmitted through the signal transceiver 5 for storage in the offsite CPU 19 or decoding in the event of an occurrence to start the third party verified data analysis and introduction as evidence.

FIG. 15b illustrates the data flow of the system of FIG. 15a. Data from camera image 120 and data from information sensors 121 is routed through the signal transceiver 5, CPU 6, and encryption/signal coding 44. In the event of live transmission to off site CPU 6, the data is routed for direct transmission through signal transceiver 5 to off site CPU 19, or is encoded 39 and routed to hard drive 45 for storage. The data in the hard drive 45 is continually being rewritten until the data is directed to be preserved. The data can be encoded for secure transmission 39, or routed from hard drive 45 to signal transmitter 5 to the off site CPU 19.

A detail of the image resolution is to follow.

An example of a possible image resolution can be seen in Table 1 below.

TABLE 1

| | |
|---|---|
| VERTICAL RESOLUTION | 1,200 |
| HORIZONTAL RESOLUTION | 1,600 |
| | 1,920,000 |
| FPS (FRAMES-PER-SECOND) | 5 |
| | 9,600,000 |
| CAMERA/LENS CONFIGURATION | Pinhole |
| VIDEO SEQUENCE | Stop Action |
| SPEED = 60 MPH | 88 feet/second |
| FT VEHICLE TRAVELS/FRAME | 18 |
| TOTAL MINUTES | 15 |
| FLASH PROCESSOR CAPACITY | 8,640,000,000 |

Video sequence(s) access may be restricted for review only by an authorized third-party (ATP) (e.g., Third Party Service Provider 201). A detailed and proprietary encryption sequence may be developed for ATP analysts exclusively. The ability to guarantee authenticity is critical for the submission of the video evidence into legal proceedings (e.g., court proceedings). The V-RAD hardware system may encrypt the video “loop” after activation. Following its termination of the respective loop, the file may be archived in the on-board hard-drive. The device may then be either directly connected or remotely connected (e.g., via secure internet connection or for fixed applications inside a cab by short-range carrier 802.11b, low-power data transceiver system, etc.) to an ATP for download, decryption, review and/or analysis. During the decryption process, the ATP's registration number may be encoded with a “virtual water-mark” on the file for chain-of-custody purposes (including time and date of access). Following the authorization of the ATP's registration number, the file may be downloaded (e.g., to CD, DVD, or analog medium). The file may, for example, be in the form of an MPEG-2 digital file. When downloading from the VIMS version of the system, the ATP may have time/date prompts from which to select scenes. Once a scene is opened, it may be permanently marked with the ATP's registration number. Multiple ATP's may access the same file, and each may be logged in the respective file's “virtual water-mark.”

A single software system may accompany the VISE and VIMS versions of the V-RAD, each containing a single-user license. The software may enable the customer to program the VISE and VIMS version of the system prior to installation into a vehicle. Software may be, for example, a DOS based system with serial port program capability. The software may be based on any other appropriate platform. The Analysis software may be available only to authorized ATP's who have completed the registration process. Each may be a single user license and may require on-line, live activation prior to issuance of an authorization code. The ATP software may contain the decryption algorithms for video, audio, and project or product tracking retrieval and analysis, as well as standardized methods of storage and download.

A key component of the V-RAD is the development of an “Authorized Third Party” evidentiary verification system. The ATP may act as an intermediary between the owner/operator of the vehicle and the insured, providing an unbiased report pertaining to:

1. The incident (e.g., relating to causes that were either in or out of the control of the operator).

2. The pre-alarm findings (e.g., what lead-up to the circumstance and again was the operator in or out of control of the events).

3. The post-alarm findings (e.g., what events took place following the event and what were the specific actions of the operator).

The development of the ATP verification system may, for example, be a collaborative effort between the insured, law enforcement, judiciary council and various representatives from the transportation 1, crane and rigging 2, and other equipment 3 industries.

While a number of features and embodiments have been discussed above, those of skill in the art will recognize additional modifications, permutations, additions and sub-combinations. It is therefore intended that the following appended claims hereinafter introduced are interpreted to include all such modifications, permutations, additions and sub-combinations that are within their true spirit and scope. Each apparatus embodiment described herein has numerous equivalents.

1.-22. (canceled)

23. A method of documenting an event, said method comprising:
obtaining a recording device from a documentation verification services provider;
recording digital information related to said event with said recording device; and
encoding said digital information.

24. The method of claim 23, wherein said recording device is tamper-resistant.

25. The method of claim 23, event is agreement by a party to at least one condition.

26. The method of claim 25, wherein data related to said at least one condition is displayed to said party, wherein said agreement by said party acknowledges the validity of said at least one condition.

27. The method of claim 26, wherein said agreement is by signature, wherein said digital information includes said signature and said at least one condition.

28. The method of claim 26, wherein said agreement is verbal, wherein said digital information includes a recording of said verbal agreement and said at least one condition.

29. The method of claim 28, wherein said recording of said verbal agreement is at least one of an audio recording and a video recording.

30. The method of claim 23, wherein said event results in a loss.

31. The method of claim 30, wherein said recording of digital information includes at least one of audio, still images and video of said event.

32. The method of claim 31, wherein said event is at least one of a vehicular accident and an industrial accident.

33. The method of claim 31, wherein said event is a crime.

34. The method of claim 23, wherein said event is a proceeding.

35. The method of claim 34, wherein said recording of digital information includes at least one of audio, still images and video of said proceeding.

36. The method of claim 35, wherein said proceeding is at least one of a medical proceeding and a legal proceeding.

37. The method of claim 23, wherein said event is an investigation.

38. The method of claim 37, wherein said recording of digital information includes at least one of audio, still images and video of said investigation.

39. The method of claim 38, wherein said investigation is of a hazardous materials spill.

40. The method of claim 38, wherein said investigation is of an accident.

41. The method of claim 23, wherein said encoded digital information is encrypted.

42. The method of claim 23, wherein said encoded digital information is at least one of watermarked and encrypted.

43. The method of claim 42, further comprising transmitting said information to said documentation verification services provider.

44. The method of claim 43, wherein said transmitting comprises transmitting over at least one of a satellite network, a telephone network, a wireless network, a computer network and the Internet.

45. The method of claim 44, further comprising verifying, by said documentation verification services provider, the authenticity of said information.

46. A method of verifying an event, said method comprising:
providing a recording device to a client;
receiving said recording device from said client after said providing step, wherein while said recording device was in control of said client, said recording device was used to make a recording of said event; and
verifying, after said receiving step, that said recording device has not been tampered with.

47. The method of claim 46, further comprising certifying that said recording has not been altered.

48. The method of claim 47, wherein said recording is operable to be admitted as evidence in legal proceeding.

49. The method of claim 46, further comprising decrypting said recording.

50. A method of verifying an event, said method comprising:
providing a recording device to a client;
receiving a digital file from said client, wherein said digital file contains a recording of said event made by said client with said recording device; and
verifying, after said receiving step, that said digital file has not been tampered with.

51. The method of claim 50, further comprising certifying that said recording has not been altered.

52.-85. (canceled)
